(19) United States
(12) Patent Application Publication
(10) Pub. No.: US 2025/0361680 A1
(43) Pub. Date: Nov. 27, 2025

(54) Anionic Dry Strength Additives And Methods Thereof

(71) Applicant: ECOLAB USA INC., Eagan, MN (US)

(72) Inventors: Jia-Yu Wang, Eagan, MN (US); Mei Liu, Eagan, MN (US); Gary Furman, Eagan, MN (US); Megan Wall, Eagan, MN (US)

(21) Appl. No.: 19/217,912

(22) Filed: May 23, 2025

Related U.S. Application Data
(60) Provisional application No. 63/651,816, filed on May 24, 2024.

(51) Int. Cl. D21H 17/55; D21H 11/12; D21H 11/14; D21H 27/00

(52) U.S. Cl. CPC D21H 17/55; D21H 11/12; D21H 11/14; D21H 27/005

(57) ABSTRACT

The present disclosure provides a paper strength additive composition comprising an anionic dialdehyde-modified polymeric dry strength resin and a cationic wet strength resin, wherein said anionic dry strength resin has a charge density in the range of about 1.0 to about 6.0 meg/g at neutral pH, and the use thereof for the improving towel paper making process. The present disclosure provides paper product comprising said paper strength additive composition.

### CROSS REFERENCE TO RELATED APPLICATIONS

This application claims priority to U.S. Application No. 63/651,816, filed on May 24, 2024, the contents of which is hereby incorporated by reference in its entirety.

### FIELD OF THE INVENTION

The present disclosure relates to compositions and methods for improving both the dry and wet strength of tissue and towel paper products. More particularly, it pertains to anionic glyoxylated polyacrylamide (AGPAM) dry strength aids compositions and methods of use for improving the strength of tissue and towel paper products thereof.

### BACKGROUND

In manufacture of paper the properties of the fiber stock as well as the final paper are modified by adding various chemicals to the fiber stock before the formation of the paper web. A crucial property for paper towel is strength, including dry strength, wet strength, and the wet-to-dry strength ratio. To achieve specific strength targets, towel papermakers often employ a combination of wet and dry strength additives. At present, a common wet strength additive is a cationic polyaminoamide-epichlorohydrin (PAE) resin. Dry strength additives include natural polymers, such as cationic starch, carboxymethyl cellulose (CMC), and guar gum, and synthetic polymers such as polyacrylamide (cationic, anionic and amphoteric), cationic glyoxylated polyacrylamides (GPAMs), and polyvinylamine, among others. Among these dry strength additives, an anionic dry strength additive has found a wider use as it helps improve PAE retention on fiber surface. This enhanced retention synergistically increases both dry and wet strength in the final paper towel product.

Currently, there are two main types of anionic dry strength additives on market. One is carboxymethyl cellulose (CMC). CMC is a natural polymer derived from cellulose by modifying with chloroacetate. This process introduces anionic charges via carboxyl groups. CMC is attractive to towel papermakers due to its low cost. However, handling CMC can be challenging as CMC is supplied as a solid powder which requires a significant investment in makedown equipment and an extra effort on makedown process. Additionally, CMC tends to promote biological growth and cause deposit issues. As a result, anionic polyacrylamide (APAM) has emerged as an economically viable liquid alternative to CMC.

Recently, US patent U.S. Pat. No. 9,951,475 taught the use of anionic glyoxylated polyacrylamide (AGPAM) in conjunction with cationic wet strength resin plus a flocculant to increase the wet and dry strength of paper towel, wherein addition of AGPAM occurs in the wet end of a papermaking process after the substrate has passed through a screen but before the substrate enters a headbox. US patent application publication 2018/0298556 further refined this method by introducing a weight ratio of PAE-to-AGPAM from about 5:1 to about 1:1.6. Cationic GPAM has been widely used in the papermaking process either as a dewatering aid or a strength aid or both due to its effectiveness in improving retention and dewatering during the papermaking process. However, the practice of anionic GPAM limits to the examples mentioned above. There is a clear need to further optimize the strength additives and their application methods to achieve a more efficient overall strength program that allows to improve strength gain, reduce chemical usage and cost, improve machine runnability and productivity, lower energy consumption, and ultimately, enhance environmental sustainability.

This background information is provided for the purpose of making information believed by the applicant to be of possible relevance to the present invention. No admission is necessarily intended, nor should it be construed, that any of the preceding information constitutes prior art against the present invention. In addition, the preceding information should not be construed to mean that a search has been made or that no other pertinent information as defined in 37 CFR § 1.56 (a) exists.

### SUMMARY

In an aspect, the present disclosure provides a paper strength additive composition, said composition comprising: an anionic dialdehyde-modified polymeric dry strength resin and a cationic wet strength resin, wherein said anionic dry strength resin has a charge density in the range of about 1.0 to about 6.0 milliequivalents per gram (meg/g), about 1.5 to about 5.4 meg/g, or about 1.8 to about 4.0 meg/g, at neutral pH.

In another aspect, the present disclosure provides a paper strength additive composition, said composition comprising a PAE resin and an AGPAM, wherein said AGPAM has a charge density in the range of about 1.0 to about 6.0 meg/g, about 1.5 to about 5.4 meg/g, or about 1.8 to about 4.0 meg/g, at neutral pH.

In a further aspect, the present disclosure provides a method of increasing the strength of tissue paper or towel paper, said method comprising contacting a composition according to any of the preceding aspects with fiber during the towel papermaking process (specifically the towel paper making or tissue paper making process).

Another aspect of the present disclosure relates to a method of increasing the strength of tissue paper or towel paper, said method comprising contacting an anionic dialdehyde-modified polymeric dry strength resin with a charge density in the range of about 1.0 to about 6.0 meg/g at neutral pH and a cationic wet strength resin, with fiber during the towel papermaking process.

An additional aspect of the present disclosure pertains to a composition, said composition comprising an anionic dialdehyde-modified polymeric dry strength resin, a cationic wet strength resin, and fiber, wherein said anionic dry strength resin has a charge density in the range of about 1.0 to about 6.0 meg/g, about 1.5 to about 5.4 meg/g, or about 1.8 to about 4.0 meg/g, at neutral pH.

In another aspect, the present disclosure provides a paper making slurry comprising an anionic dialdehyde-modified polymeric dry strength resin, a cationic wet strength resin, water, and fiber, wherein the slurry has a consistency of about 0.05 to about 0.2% (or about 0.1%), and wherein said anionic dry strength resin has a charge density in the range of about 1.0 to about 6.0 meg/g, about 1.5 to about 5.4 meg/g, or about 1.8 to about 4.0 meg/g, at neutral pH.

As used herein, the term “paper making slurry” refers to a mixture of water and paper pulp produced during the stock preparation phase of paper making.

In one aspect, the present disclosure provides a paper product (e.g. tissue paper, towel paper, etc.), said product comprising fiber, an anionic dialdehyde-modified polymeric dry strength resin, and a cationic wet strength resin, wherein said anionic dry strength resin has a charge density in the range of about 1.0 to about 6.0 meg/g, about 1.5 to about 5.4 meg/g, or about 1.8 to about 4.0 meg/g, at neutral pH, and wherein said product has a basis weight in the range of about 8 g/m² to 40 g/m² (about 15-25 g/m², or about 20 g/m²).

### DETAILED DESCRIPTION

### Definitions

The following definitions are provided to determine how terms used in this application, and in particular, how the claims are to be construed. The organization of the definitions is for convenience only and is not intended to limit any of the definitions to any particular category.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

The terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein.

All methods described herein may be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments may be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

“AA” means acrylic acid.

“AcAm” means acrylamide.

“Wet end” means that portion of the papermaking process prior to a press section where a liquid medium such as water typically comprises more than 45% of the mass of the substrate. Additives added in a wet end typically penetrate and distribute within the slurry.

“Dry end” means that portion of the papermaking process including and subsequent to a press section where a liquid medium such as water typically comprises less than 45% of the mass of the substrate. Additives added in a dry end typically remain in a distinct coating layer outside of the slurry. Dry end includes but is not limited to the size press portion of a papermaking process, “Acrylamide monomer” means a monomer of formula

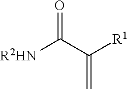

wherein R¹ is selected from the group consisting of H, C₁-C₁₆ alkyl, aryl, arylalkyl, C₂-C₁₆ alkenyl, C₂-C₁₆ alkynyl, heteroaryl, alkylheteroaryl, C₃-C₈ cycloalkyl, and halogen; and R² is selected from the group consisting of hydrogen, C₁-C₁₆ alkyl, aryl, arylalkyl, C₂-C₁₆ alkenyl, C₂-C₁₆ alkynyl, heteroaryl, alkylheteroaryl, and hydroxyl.

“Aldehyde” means a compound containing one or more aldehyde (—CHO) groups, where the aldehyde groups are capable of reacting with the amino or amide groups of a polymer comprising amino or amide groups as described herein. Representative aldehydes include formaldehyde, paraformaldehyde, glutaraldehyde, glyoxal, and the like.

“Aldehyde-functionalized polymer” (is used interchangeably with the acronym “AFP”) to refer to a polymer that results from a reaction between a polymer comprising at least one amide group or amino group with an aldehyde. The term “aldehyde-functionalized polymer” encompasses an aldehyde-functionalized polymer composition or mixture containing unreacted aldehyde. The term “aldehyde-functionalized polymer” also encompasses an aqueous aldehyde-functionalized polymer composition or mixture containing unreacted aldehyde.

“Alkenyl” refers to a straight or branched hydrocarbon, preferably having 2, 3, 4, 5, 6, 7, 8, 9, 10, 11, 12, 13, 14, 15, or 16 carbons, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups may be unsubstituted or substituted by one or more suitable substituents.

“Alkyl” refers to a straight-chain or branched alkyl substituent. Examples of such substituents include methyl, ethyl, propyl, isopropyl, n-butyl, sec-butyl, isobutyl, tert-butyl, pentyl, isoamyl, hexyl, and the like.

“Alkylheteroaryl” refers to an alkyl group linked to a heteroaryl group.

“Alkynyl” refers to a straight or ranched hydrocarbon, preferably having 2, 3, 4, 5, 6, 7, 8, 9, 10, 11, 12, 13, 14, 15, or 16 carbons, and having one or more carbon-carbon triple bonds. Alkynyl groups include, but are not limited to, ethynyl, propynyl, and butynyl. Alkynyl groups may be unsubstituted or substituted by one or more suitable substituents.

“Amide group” means a group of formula —C(O)NHY₁ where Y₁ is selected from the group consisting of hydrogen, C₁-C₁₆ alkyl, aryl, arylalkyl, C₂-C₁₆ alkenyl, C₂-C₁₆ alkynyl, heteroaryl, alkylheteroaryl, or hydroxyl.

“Amino group” means a group of formula —NH(Y)₂ where each of Y₂ may be the same or different and each of Y is selected from the group consisting of hydrogen, C₁-C₁₆ alkyl, aryl, arylalkyl, C₂-C₁₆ alkenyl, C₂-C₁₆ alkynyl, heteroaryl, alkylheteroaryl, or hydroxyl.

“Amphoteric polymer” refers to a polymer derived from both cationic monomers and anionic monomers, and, possibly, other nonionic monomer(s). Representative amphoteric polymers include copolymers composed of terpolymers composed of acrylic acid, DADMAC and acrylamide, and the like.

“Aryl” refers to an unsubstituted or substituted aromatic carbocyclic substituent, as commonly understood in the art, and the term “C₆-C₁₀ aryl” includes phenyl and naphthyl. It is understood that the term aryl applies to cyclic substituents that are planar and comprise 4n+2n electrons, according to Hückel's Rule.

“Arylalkyl” means an aryl-alkylene group where aryl and alkylene are defined herein. Representative arylalkyl groups include benzyl, phenylethyl, phenylpropyl, 1-naphthylmethyl, and the like.

“Contacting” as used herein in the context of application of the AGPAM product prepared according to the methods disclosed herein, refers to combining said AGPAM with a fiber slurry, or applying said AGPAM to a paper sheet.

“Consisting essentially of” means that the methods and compositions may include additional steps, components, ingredients or the like, but only if the additional steps, components and/or ingredients do not materially alter the basic and novel characteristics of the claimed methods and compositions.

“Continuously measuring” as used herein refers to monitoring by the progress of the reaction of step (a) by measuring the viscosity of the reaction solution (e.g., via feedback loop) from an online viscosity meter. In some embodiments, continuous measurement of the progress of the reaction may be done in real time, optionally with feedback control.

“DADMAC” refers to monomeric units of diallyldimethylammonium halide such as diallyldimethylammonium chloride. DADMAC may be present in a homopolymer or in a copolymer comprising other monomeric units.

“Diallyl-N,N-disubstituted ammonium halide monomer” means a monomer of formula: (H₂C═CHCH₂)₂N+R₃R₄X⁻

wherein R₃ and R₄ are independently C₁-C₂₀ alkyl, aryl or arylalkyl and X is an anionic counterion. Representative anionic counterions include halogen, sulfate, nitrate, phosphate, and the like. A preferred anionic counterion is halogen. Halogen is preferred. A preferred diallyl-N,N-disubstituted ammonium halide monomer is diallyldimethylammonium chloride.

“Halogen” or “halo” refers to a moiety selected from the group consisting of fluorine, chlorine, bromine, and iodine.

“AGPAM” as used herein to refers to anionic glyoxalated polyacrylamide, which is a polymer made from polymerized acrylamide monomers (which may or may not be a copolymer comprising one or more other monomers as well) and in which acrylamide polymeric units have been reacted with glyoxal groups, representative examples of AGPAM are described in PCT Publication No. WO2022/110102. As used herein, the term “AGPAM” encompasses a AGPAM composition or mixture containing unreacted aldehyde (glyoxal). Furthermore, as used herein, the term “AGPAM” encompasses an aqueous AGPAM composition or mixture containing unreacted aldehyde (glyoxal). AGPAM is used herein as an exemplary embodiment. The invention contemplates substituting other all AFPs, as defined herein, in place of AGPAM.

“Monomer” means a polymerizable allylic, vinylic, or acrylic compound. The monomer may be anionic, cationic, nonionic, or zwitterionic.

Representative non-ionic, water-soluble monomers include acrylamide, methacrylamide, N,N-dimethylacrylamide, N,N-diethylacrylamide, N-isopropylacrylamide, N-vinylformamide, N-vinylmethylacetamide, N-vinyl pyrrolidone, hydroxyethyl methacrylate, hydroxyethyl acrylate, hydroxypropyl acrylate, hydroxypropyl methacrylate, N-t-butylacrylamide, N-methylolacrylamide, vinyl acetate, vinyl alcohol, and the like.

Representative anionic monomers include acrylic acid, and it's salts, including, but not limited to sodium acrylate, and ammonium acrylate, methacrylic acid, and it's salts, including, but not limited to sodium methacrylate, and ammonium methacrylate, 2-acrylamido-2-methylpropanesulfonic acid (AMPS), the sodium salt of AMPS, sodium vinyl sulfonate, styrene sulfonate, maleic acid, and it's salts, including, but not limited to the sodium salt, and ammonium salt, sulfonate, itaconate, sulfopropyl acrylate or methacrylate or other water-soluble forms of these or other polymerisable carboxylic or sulphonic acids. Sulfomethylated acrylamide, allyl sulfonate, sodium vinyl sulfonate, itaconic acid, acrylamidomethylbutanoic acid, fumaric acid, vinylphosphonic acid, vinylsulfonic acid, allylphosphonic acid, sulfomethylated acrylamide, phosphonomethylated acrylamide, itaconic anhydride, and the like.

Representative cationic monomers include allyl amine, vinyl amine, dialkylaminoalkyl acrylates and methacrylates and their quaternary or acid salts, including, but not limited to, dimethylaminoethyl acrylate methyl chloride quaternary salt (DMAEA.MCQ), dimethylaminoethyl acrylate methyl sulfate quaternary salt, dimethyaminoethyl acrylate benzyl chloride quaternary salt, dimethylaminoethyl acrylate sulfuric acid salt, dimethylaminoethyl acrylate hydrochloric acid salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate, diallyldiethylammonium chloride and diallyldimethyl ammonium chloride (DADMAC). Alkyl groups are generally C₁-4 alkyl.

The term “molecular weight” or “MW” as used herein refers to weight average molecular weight. Weight average molecular weight may be determined by any suitable technique. While alternate techniques are envisioned, in some embodiments, the weight average molecular weight is determined using size exclusion chromatography (SEC) equipped with a set of TSKgel PW columns (TSKgel Guard+GMPW+GMPW+G1000 PW), Tosoh Bioscience LLC, Cincinnati, Ohio) and a Waters 2414 (Waters Corporation, Milford, Mass.) refractive index detector or a DAWN HELEOS II multi-angle light scattering (MALS) detector (Wyatt Technology, Santa Barbara, Calif.). Moreover, the weight average molecular weight is determined from either calibration with polyethylene oxide/polyethylene glycol standards ranging from 150-875,000 Daltons or directly using light scattering data with known refractive index increment (“dn/dc”).

The term “viscosity” as used herein refers to the internal friction or molecular attraction of a given material which manifests itself in resistance to flow. It is measured in liquids by standard test procedures and is usually expressed in poise or centipoise (cP) at a specified temperature. The viscosity of a fluid is an indication of a number of behavior patterns of the liquid at a given temperature including pumping characteristics, rate of flow, wetting properties, and a tendency or capacity to suspend an insoluble particulate material. As used herein, viscosity is based on a measurement at ambient temperature and at about 6% to about 15% concentration solids of the reaction solution.

The term “viscosity meter” is used interchangeably herein with “viscometer”.

The term “online viscometer” as herein refers to an open flow tube type viscometer and the like that (i) lack a spindle or probe and (ii) is not susceptible to complete blockage or fouling by gelling of an aldehyde functionalized polymer (such as GPAM) and (iii) which can provide continuous real time viscosity measurements via a feedback loop. As used herein, online viscosity meter includes viscometers such as concentric cylinder geometry (Couette type) viscometers which can provide viscosity measurements at defined shear conditions (i.e., a Couette viscometer, e.g. BROOKFIELD TT-100 Viscometer), vibration meters, viscometers based on a Coriolis mass flow measuring system (such as those where measuring is based on a torsional movement of a measurement tube, e.g., Endress+Hauser Proline 831), etc. The online viscometer enables reliable reaction control and may facilitate automated quenching of the reaction mixture once a target viscosity level is reached.

“Zwitterionic monomer” means a polymerizable molecule containing cationic and anionic (charged) functionality in equal proportions, so that the molecule is net neutral overall. Representative zwitterionic monomers include N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine (MPC), 2-[(3-acrylamidopropyl)dimethylammonio]ethyl 2′-isopropyl phosphate (AAPI), 1-vinyl-3-(3-sulfopropyl) imidazolium hydroxide, (2-acryloxyethyl)carboxymethyl methylsulfonium chloride, 1-(3-sulfopropyl)-2-vinylpyridinium betaine, N-(4-sulfobutyl)-N-methyl-N, N-diallylamine ammonium betaine (MDABS), N,N-diallyl-N-methyl-N-(2-sulfoethyl)ammonium betaine, and the like.

“Papermaking process” means any portion of a method of making paper products from pulp comprising forming an aqueous cellulosic papermaking furnish, draining the furnish to form a sheet and drying the sheet. The steps of forming the papermaking furnish, draining and drying may be carried out in any conventional manner generally known to those skilled in the art. The papermaking process may also include a pulping stage, i.e. making pulp from a lignocellulosic raw material and bleaching stage, i.e. chemical treatment of the pulp for brightness improvement, papermaking is further described in the reference Handbook for Pulp and Paper Technologists, 3rd Edition, by Gary A. Smook, Angus Wilde Publications Inc., (2002) and The Nalco Water Handbook (3rd Edition), by Daniel Flynn, McGraw Hill (2009) in general and in particular pp. 32.1-32.44. “Papermaking process” includes methods of making paper products from pulp comprising forming an aqueous cellulosic papermaking furnish, draining the furnish to form a sheet and drying the sheet. The steps of forming the papermaking furnish, draining and drying may be carried out in any conventional manner generally known to those skilled in the art. Conventional microparticles, alum, cationic starch or a combination thereof may be utilized as adjuncts with the polymer treatment of this invention, though it should be emphasized that no adjunct is required for effective dewatering activity.

“Dry Strength” means the tendency of a paper substrate to resist damage when it is in a dry state.

“Wet Strength” means the tendency of a paper substrate to resist damage when it is in a wet state.

“Substrate” means a mass containing paper fibers going through or having gone through a papermaking process, substrates include wet web, paper mat, slurry, paper sheet, and paper products.

As used herein, “Paper Product” refers to any formed, fibrous structure products, traditionally, but not necessarily, comprising cellulose fibers. Further, “Paper Product” refers the end product of a papermaking process. It includes but is not limited to towel paper, writing paper, printer paper, tissue paper, cardboard, paperboard, and packaging paper. In some embodiments, the term “paper product” refers to a paper product with a basis weight in the range of about 8 g/m² to 40 g/m², or in the range of about 15 g/m² to about 25 g/m², or with a basis weight of about 20 g/m².

The term “initial viscosity” as used herein is obtained by measuring the viscosity of the reaction solution up to about 5 minutes after a polymer comprising at least one amide group or amino group is combined with aldehyde. The initial viscosity may be measured via feedback loop from an online viscosity meter or by other means. For example, the initial viscosity encompasses viscosity of the reaction solution up to 5 minutes after polyacrylamide is combined with glyoxal.

The term “target viscosity change” as used herein refers where the change in the viscosity of the reaction solution has reached an increase greater than 50% in viscosity over the initial viscosity of the reaction solution. In some embodiments, the target viscosity change occurs where the viscosity of the reaction solution has reached an increase greater than 100% in viscosity over the starting viscosity. The target viscosity change may occur when the viscosity of the reaction solution has reached an increase in viscosity of, about 50%, about 60%, about 70%, about 80%, about 90%, about 100%, about 200%, about 300%, about 400%, about 500%, about 100% to about 500%, about 200% to about 500%, or about 300% to about 500%, over the starting viscosity.

The term “reaction solution” as used herein refers to a reaction mixture formed after the combination of after a polymer comprising at least one amide group or amino group (such as polyacrylamide) is combined with aldehyde (e.g. glyoxal) in the preparation of AFPs, such as GPAM. The reaction solution may comprise moieties such as AFP (such as GPAM), unreacted aldehyde (such as glyoxal), unreacted polyacrylamide, intermediates in the formation of AFPs, etc. Furthermore, the reaction solution may also include unreacted acrylamide and unreacted ionic monomer.

Basis weight, as used herein, is the weight per unit area of a sample reported in lbs/3000 ft² or g/m². The paper products disclosed herein may exhibit a basis weigh of between 8 g/m² to about 40 g/m² and/or from about 15 g/m² to about 25 g/m² and/or about 20 g/m².

Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield.

Weights are recorded when the readings on the balance become constant. The average weight (g) is calculated and the average area of the samples (m²). The basis weight (g/m²) is calculated by dividing the average weight (g) by the average area of the samples (m²).

“Fiber”, as used herein, means an elongate physical structure having an apparent length greatly exceeding it apparent diameter, i.e. a length to diameter ratio of at least about 10 and less than 200. Fibers having a non-circular cross-section and/or tubular shape are common; the “diameter” in this case may be considered to be the diameter of a circle having cross-sectional are equal to the cross-sectional area of the fiber. More specifically, as used herein, “fiber” refers to fibrous structure-making fibers. The present invention contemplates the use of a variety of fibrous structure-making fibers, such as, for example, natural fibers, such as cellulose nanofilaments and/or wood pulp fibers, non-wood fibers or any suitable fibers and any combination thereof.

Natural fibrous structure-making fibers, also called non-wood fibers, useful in the present invention include animal fibers, mineral fibers, plant fibers, man-made spun fibers, and engineered fibrous elements such as cellulose nanofilaments. Animal fibers may, for example be selected from the group consisting of wool, silk, and mixtures thereof. The plant fibers may, for example, be derived from a plant selected from the group consisting of wood, cotton, cotton linters, flax, sisal, abaca, hemp, hesperaloe, jute, bamboo, bagasse, esparto grass, straw, jute, hemp, milkweed floss, kudzu, corn, sorghum, gourd, agave, trichomes, loofah and mixtures thereof.

Wood fibers, often referred to as wood pulps, are liberated from their source by any one of a number of chemical pulping processes familiar to one experienced in the art, including kraft (sulfate), sulfite, polysulfide, soda pulping, etc. Further, the fibers may be liberated from their source using mechanical and semi-chemical processes including, for example, roundwood, thermomechanical pulp, chemo-mechanical pulp (CMP), chemi-thermomechanical pulp (CTMP), alkaline peroxide mechanical pulp (APMP), neutral semi-chemical sulfite pulp (NSCS), are also contemplated. The pulp may be whitened, if desired, by any one or combination of processes familiar to one experienced in the art including the use of chlorine dioxide, oxygen, alkaline peroxide, and so forth. Chemical pulps, however, may be preferred since they impart superior tactile feel and/or desired tissue sheet properties. Pulps derived from both deciduous trees (hereinafter, referred to “hardwood”) and coniferous trees (hereinafter, also referred to as “softwood”) may be utilized and/or fibers derived from non-woody plants along with man-made fibers. The hardwood, softwood, and/or non-wood fibers may be blended, or alternately, may be deposited in layers to provide a stratified and/or layered web. U.S. Pat. Nos. 4,300,981 and 3,994,771 disclose layering of softwood and hardwood fibers. Also applicable to the present invention are fibers derived from recycled paper, as well as other non-fibrous materials, such as adhesives used to facilitate the original papermaking and paper converting. The wood pulp fibers may be short (typical of hardwood fibers) or long (typical of softwood fibers and some non-wood fibers).

Examples of softwood fibers that may be used in the paper towel webs of the present invention include but are not limited to fibers derived from pine, spruce, fir, tamarack, hemlock, cypress, and cedar. Softwood fibers derived from the kraft process and originating from more-northern climates may be preferred. These are often referred to as northern bleached softwood kraft (NBSK) pulps.

Non-limiting examples of short hardwood fibers include fibers derived from a fiber source selected from the group consisting of acacia, eucalyptus, maple, oak, aspen, birch, cottonwood, alder, ash, cherry, elm, hickory, poplar, gum, walnut, locust, sycamore, beech, catalpa, sassafras, gmelin, albizia, and magnolia. Hardwood fibers derived from the kraft process and originating from more-northern climates like Eucalyptus may be preferred. These are often referred to as northern bleached hardwood kraft (NBHK) pulps.

The term “non-wood fiber” as used herein refers to non-wood fibers, also known as alternative or agricultural fibers, are plant-based materials used as a sustainable alternative to wood in various applications, including pulp and paper, building materials, and textiles. These fibers can be sourced from crop residues, agricultural byproducts, or purpose-grown plants like bamboo. Examples include wheat straw, sugarcane bagasse, hemp, kenaf, jute, and cotton stalks.

As used herein, “polymer charge density” refers to the amount of net charge of a given polymer per unit weight. It is typically measured in milliequivalents per gram (meg/g) of product solids at a given pH. To measure the charge density of the dry strength resins of the present invention, a colloid titration method is used. For a cationic polymer, a standard of 0.001 N potassium polyvinyl sulfate (PVSK) solution is used as the titrant. For an anionic polymer, a standard of 0.001 N polydiallyldimethylammonium chloride (PolyDADMAC) solution is used as the titrant. During the titration test, the standard titrant is used to titrate the test solution to a 0 mV potential. A Mutek particle charge detector, or its equivalent, is used for end point detection. The charge density is calculated from the average duplicate titration results.

As used herein, the term “consistency” refers to the percentage of dry solids in the pulp slurry, which is made up of fibers, water, fines, and fillers.

As used herein, the term “slurry” refers to a mixture of water and pulp fibers that is produced during the stock preparation phase of papermaking. The relative amount of fibers and water within the slurry can vary according to the desired use and need. In some embodiments, the amounts of fibers within a slurry may be in the range of about 0.05 to about 0.2%, or about 0.1%. As used herein, the term “meg/g” refers to milliequivalents per gram.

As used herein, the term “towel paper making process” refers to the preparation of a paper product such as towel paper, tissue paper, etc. from paper pulp by contacting fiber with a paper strength additive composition disclosed herein. In some embodiments, this process includes preparation of paper product with a basis weight in the range of about 8 g/m² to 40 g/m², or in the range of about 15 g/m² to about 25 g/m², or has a basis weight of about 20 g/m².

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

In some embodiments, the present disclosure pertains to the paper strength additive composition, wherein said anionic dry strength resin is a dialdehyde-modified polymer mixture comprising a solvent and a dialdehyde modified polymer comprising:
a polymer backbone comprising:
   i. one or more monomer unit(s) derived from a monomer of Formula I:

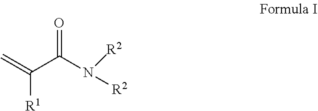

wherein R¹ is H or C₁-C₄ alkyl and each R₂ is independently selected from H or a linear or branched C₁-C₁₀ aliphatic group,
   ii. about 3 mol % to about 50 mol % of one or more anionic monomer unit(s); and
   iii. optionally about 3 mol % to about 50 mol % of one or more cationic monomer unit(s).

The one or more anionic monomer unit(s) is derived from a monomer selected from 2-acrylamido-2-methylpropane sulfonic acid (“AMPS”), 2-acrylamido-2-methylbutane sulfonic acid (“AMBS”), [2-methyl-2-[(1-oxo-2-propenyl)amino]propyl]-phosphonic acid, methacrylic acid, acrylic acid, salts thereof, and combinations thereof. Further, the one or more anionic monomer unit(s) may be derived from acrylic acid.

The one or more cationic monomer unit(s) is derived from a monomer selected from dimethylaminoethyl acrylate methyl chloride quaternary salt (DMAEA.MCQ), dimethyaminoethyl acrylate benzyl chloride quaternary salt, dimethylaminoethyl methacrylate methyl chloride quaternary salt, dimethylaminoethyl methacrylate benzyl chloride quaternary salt, dialkylaminoalkylacrylamides or methacrylamides and their quaternary or acid salts, and diallyldimethyl ammonium chloride (DADMAC), and combinations thereof.

In some embodiments, the monomer of Formula I is acrylamide, methacrylamide, ethylacrylamide, N-methyl acrylamide, N-butyl acrylamide, or any combination thereof. In other embodiments, the monomer of Formula I is acrylamide.

In some embodiments, the dialdehyde-modified polymer is modified with a dialdehyde selected from glyoxal, malondialdehyde, succinic dialdehyde, and glutaraldehyde. In other embodiments, the dialdehyde is glyoxal.

In some embodiments, the dialdehyde modified polymer has an anionic charge density in the range of about 1.5 to about 5.4 meg/g at neutral pH, in the range of about 1.0 to about 6.0 meg/g, in the range of about 1.5 to about 4.5 meg/g, or in the range of about 1.8 meg/g to about 4.0 meg/g at neutral pH.

In some embodiments, the dialdehyde-modified polymer has a weight average molecular weight of from about 50 kDa to about 3,000 kDa, or from about 100 kDa to about 2,000 kDa. In other embodiments, the polymer backbone has a weight average molecular weight in the range of about 2 kDa to about 100 kDa in the absence of the dialdehyde modification, or in the range of about 5 kDa to about 25 kDa in the absence of the dialdehyde modification.

In some embodiments, the dialdehyde-modified polymer mixture has a solids content in the range of about 1 wt. % to about 40 wt. %, or in the range of about 5 wt. % to about 25 wt. %.

In some embodiments, the dialdehyde-modified polymer mixture is an anionic glyoxylated polyacrylamide (AGPAM).

In some embodiments, said cationic wet strength resin is either a temporary wet strength resin like GPAM or a permanent wet strength resin like polyaminoamide-epichlorohydrin (PAE), urea-formaldehyde resin, melamine-formaldehyde resin, polyamines and polyethylene imides epichlorohydrin, or hydrolyzed N-vinylformamide. In other embodiments, the temporary wet strength resin is GPAM. In further embodiments, the permanent wet strength resin is chosen from polyaminoamide-epichlorohydrin (PAE), urea-formaldehyde resin, melamine-formaldehyde resin, polyamine and polyethylene imide epichlorohydrin, or hydrolyzed N-vinylformamide.

In some embodiments, the cationic wet strength resin is a PAE.

In an aspect, the present disclosure pertains to a method of increasing the strength of tissue paper, comprising contacting a paper strength additive composition disclosed herein with fiber during the towel papermaking process. In some embodiments, the composition is added to thin stock, thick stock, the headbox, before the headbox, after the headbox, or before a press section, and any combination thereof.

In an additional aspect, the present disclosure pertains to a method of increasing the strength of tissue paper or towel paper, said method comprising contacting an anionic dialdehyde-modified polymeric dry strength resin with a charge density in the range of about 1.0 to about 6.0 meg/g at neutral pH and a cationic wet strength resin, with fiber during the towel papermaking process.

In some embodiments, said contacting comprises adding said cationic wet strength resin to water during the towel paper making process and adding said anionic dialdehyde-modified polymeric dry strength resin composition to water during towel paper making process. In other embodiments, said water is present in a thin stock, a thick stock, and/or in the headbox in a papermaking machine. In further embodiments, said contacting comprises adding said cationic wet strength resin to water during the towel paper making process and adding said anionic dialdehyde-modified polymeric dry strength resin composition to thin stock, thick stock, the headbox, before the headbox, after the headbox, or before a press section, and any combination thereof. In some embodiments, said contacting comprises adding a cationic wet strength resin to towel paper making process water and adding an anionic dialdehyde-modified polymeric dry strength resin to the towel paper making process water. In yet further embodiments, said contacting comprises first adding said cationic wet strength resin to water during the towel paper making process and adding said anionic dialdehyde-modified polymeric dry strength resin at a later time. Said contacting may also comprise co-feeding said cationic wet strength resin and said anionic dialdehyde-modified polymeric dry strength resin in the towel paper making process. Said contacting may also comprise adding from about 0.1 lb/ton to about 100 lb/ton of said anionic dialdehyde-modified polymeric dry strength resin, relative to solid fiber, to stock during a towel making process.

In further embodiments, the present disclosure pertains to a method of increasing the strength of tissue paper or towel paper, said method comprising contacting an anionic dialdehyde-modified polymeric dry strength resin with an anionic charge density in the range of 1.0-6.0 meg/g at neutral pH and a cationic wet strength resin, with fiber during the towel papermaking process (e.g., the towel paper making for tissue paper making process), wherein the anionic dialdehyde-modified polymeric dry strength resin comprises a polymer backbone comprising:
i. one or more monomer unit(s) derived from a monomer of Formula I:

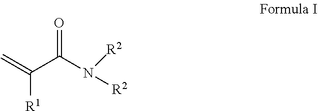

wherein R¹ is H or C₁-C₄ alkyl and each R₂ is independently selected from H or a linear or branched C₁-C₁₀ aliphatic group,
ii. about 3 mol % to about 50 mol % of one or more anionic monomer unit(s); and
iii. optionally about 3 mol % to about 50 mol % of one or more cationic monomer unit(s).

In some embodiments, the one or more anionic monomer unit(s) is derived from a monomer selected from 2-acrylamido-2-methylpropane sulfonic acid (“AMPS”), 2-acrylamido-2-methylbutane sulfonic acid (“AMBS”), [2-methyl-2-[(1-oxo-2-propenyl)amino]propyl]-phosphonic acid, methacrylic acid, acrylic acid, salts thereof, and combinations thereof. The one or more anionic monomer unit(s) may be derived from acrylic acid. Further, the monomer of Formula I may be acrylamide, methacrylamide, ethylacrylamide, N-methyl acrylamide, or N-butyl acrylamide, and any combination thereof. Additionally, the monomer of Formula I may be acrylamide.

In some embodiments, the one or more cationic monomer unit(s) is derived from a monomer selected from dimethylaminoethyl acrylate methyl chloride quaternary salt (DMAEA.MCQ), dimethyaminoethyl acrylate benzyl chloride quaternary salt, dimethylaminoethyl methacrylate methyl chloride quaternary salt, dimethylaminoethyl methacrylate benzyl chloride quaternary salt, dialkylaminoalkylacrylamides or methacrylamides and their quaternary or acid salts, and diallyldimethyl ammonium chloride (DADMAC), and combinations thereof.

In some, the dialdehyde-modified polymer is modified with a dialdehyde selected from glyoxal, malondialdehyde, succinic dialdehyde, and glutaraldehyde. In other embodiments, the dialdehyde is glyoxal. The dialdehyde-modified polymer may have an anionic charge density in the range of about 1.5 meg/g to about 5.4 meg/g at neutral pH, or in the range of about 1.8 meg/g to about 4.0 meg/g at neutral pH. Further, the dialdehyde-modified polymer may have a weight average molecular weight in the range of about 50 kDa to about 3,000 kDa, or in the range of about 100 kDa to about 2,000 kDa. In some embodiments, the polymer backbone has a weight average molecular weight in the range of about 2 kDa to about 50 kDa in the absence of the dialdehyde modification, or in the range of about 5 kDa to about 25 kDa in the absence of the dialdehyde modification. In some embodiments, the dialdehyde-modified polymer mixture has a solids content in the range of about 1 wt. % to about 40 wt. %, or in the range of about 5 wt. % to about 25 wt. %. In other embodiments, the dialdehyde-modified polymer mixture is an anionic glyoxylated polyacrylamide (AGPAM). The cationic wet strength resin may be a temporary wet strength resin, a permanent wet strength resin, or a combination thereof. In some embodiments, the temporary wet strength resin is GPAM. In other embodiments, the permanent wet strength resin is chosen from polyaminoamide-epichlorohydrin (PAE), urea-formaldehyde resin, melamine-formaldehyde resin, polyamines and polyethylene imides epichlorohydrin, or hydrolyzed N-vinylformamide. In further embodiments, the wet strength resin is a PAE. In other embodiments, the anionic dry strength resin is an anionic glyoxylated polyacrylamide (APGAM). In some embodiments, the wet strength resin is a PAE.

In still other embodiments, the method involves increasing the wet strength and/or dry strength of tissue paper and/or towel paper.

The term “fiber” as used herein refers to various types of fiber such as a wood fiber, a non-wood fiber (also known as an alternative fiber, agricultural fiber, or residue), or a recycled fiber. In some embodiments, the wood fiber comprises fibers from hardwood/deciduous trees (e.g., eucalyptus, maple, birch, aspen, etc.) or fibers from softwood/coniferous trees (e.g., spruce, pine, fir, hemlock, etc.). In other embodiments, the non-wood fiber comprises fibers from e.g., bamboo, bagasse, wheat straw, hemp, esparto, switchgrass, sorghum, miscanthus, etc. In further embodiments, the recycled fiber comprises fibers from graphic papers (e.g., mixed office waste, old newspapers, etc.) or from boards and packages (e.g., old corrugated containers, etc.).

The anionic dry strength resin disclosed herein may be a dialdehyde-modified polymer mixture. In some embodiments, the dialdehyde-modified polymer mixture comprises a solvent and a dialdehyde modified polymer comprising: (a) a polymer backbone comprising: (i) one or more monomer unit(s) derived from a monomer of Formula I:

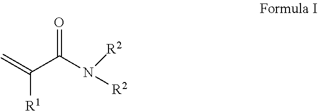

wherein R¹ is H or C₁-C₄ alkyl and each R₂ is independently selected from H or a linear or branched C₁-C₁₀ aliphatic group, (ii) about 10 mol % to about 50 mol % of one or more anionic monomer unit(s), (iii) optionally about 10 mol % or about 50 mol % of one or more cationic monomer unit(s), and (b) a dialdehyde modification to the polymer backbone, wherein the dialdehyde-modified polymer mixture has a pH of from about 4.0 to about 7.0.

In further embodiments, the dialdehyde-modified polymer mixture comprises a solvent and a dialdehyde modified polymer. The solvent may be any suitable solvent, including, e.g., water, ethanol, methanol, acetonitrile, etc., or a combination thereof. In certain embodiments, the solvent is water. The water may be from any suitable source. For example, the water may be tapwater, deionized water, distilled water, ground water, wastewater, white water, etc. In some embodiments, the mixture further comprises a solvent other than water. The solvent may be any suitable solvent (e.g., ethanol, methanol, acetonitrile, etc., or a combination thereof).

The dialdehyde-modified polymer disclosed herein comprises a polymer backbone. As used herein, the phrase “polymer backbone” refers to any polymer comprising (i) one or more monomer unit(s) derived from a monomer of Formula I, (ii) one or more anionic monomer unit(s), and (iii) optionally about 10 mol % or about 50 mol % of one or more cationic monomer unit(s). Accordingly, the polymer backbone may be considered a copolymer comprising one or more monomer unit(s) derived from a monomer of Formula I and one or more anionic monomer unit(s), and optionally one or more cationic monomer unit(s). The polymers described herein have a net negative charge and are thus considered anionic.

The polymer backbone can exist as any suitable copolymer. For example, the polymer backbone copolymer can exist as an alternating copolymer, random copolymer, block copolymer, graft copolymer, linear copolymer, branched copolymer, cyclic copolymer, or a combination thereof. The polymer backbone copolymer can contain any suitable number of differing monomer units. For example, the polymer backbone copolymer can contain 2 different monomer units, 3 different monomer units, 4 different monomer units, 5 different monomer units, or 6 different monomer units. The polymer backbone can comprise the one or more monomer unit(s) derived from a monomer of Formula I and the one or more anionic monomer unit(s) and optionally one or more cationic monomer unit(s) in any suitable concentration and any suitable proportion such that the AGPAM made of the polymer backbone has a charge density in the range of about 1.0 to about 6.0 milliequivalents per gram (meg/g), about 1.5 to about 5.4 meg/g, or about 1.8 to about 4.0 meg/g, at neutral pH.

The polymer backbone comprises one or more monomer unit(s) derived from a monomer of Formula I:

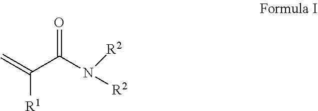

wherein R¹ is H or C₁-C₄ alkyl (e.g., methyl, ethyl, n-propyl, iso-propyl, n-butyl, sec-butyl, or tert-butyl) and each R₂ is independently selected from H or a linear or branched C₁-C₁₀ aliphatic group. As used herein, “derived” when referring to a monomer unit, means that the monomer unit has substantially the same structure of a monomer from which it was made. For example, when a carbon-carbon double bond of a terminal olefin is transformed to a carbon-carbon single bond during the process of polymerization.

Each R² is independently selected from H or a linear or branched C₁-C₁₀. As used herein, the terms “independent” and “independently,” when referring to one or more constituent (e.g., R²), means that each substituent is individually selected from the list and may be the same or different. For example, if constituent R² appears more than once in a formula and R² is independently selected from a recited list, then each R₂ may be the same or different and selected from the recited list. As used herein, “linear or branched C₁-C₁₀ aliphatic group” refers to a saturated, unsaturated, branched, straight-chained, cyclic, or a combination thereof aliphatic group having from 1 to 10 carbon atoms (i.e., 1, 2, 3, 4, 5, 6, 7, 8, 9, or 10 carbon atoms). An exemplary list of linear or branched C₁-C₁₀ aliphatic groups is methyl, ethyl, n-propyl, iso-propyl, n-butyl, sec-butyl, tert-butyl, n-pentyl, sec-pentyl, neo-pentyl, hexyl, etc. In some embodiments, the linear or branched C₁-C₁₀ aliphatic group is further substituted with one or more heteroatoms (e.g., O, S, N, and/or P).

As used herein, the term “substituted” means that one or more hydrogens on the designated atom or group are replaced with another group provided that the designated atom's normal valence is not exceeded. For example, when the substituent is oxo (i.e., ═O), then two hydrogens on the carbon atom are replaced. Combinations of substituents are permissible provided that the substitutions do not significantly adversely affect synthesis or use of the dialdehyde-modified polymer.

In some embodiments, the monomer of Formula I is acrylamide, methacrylamide, ethylacrylamide, N-methyl acrylamide, N-butyl acrylamide, or any combination thereof. In certain embodiments, the monomer of Formula I is acrylamide and/or methacrylamide. In some embodiments, the monomer of Formula I is acrylamide.

The polymer backbone can comprise the one or more monomer unit(s) derived from a monomer of Formula I and the one or more anionic monomer unit(s) in any suitable proportion such that AGPAM made of the polymer backbone has a charge density in the range of about 1.0 to about 6.0 milliequivalents per gram (meg/g), about 1.5 to about 5.4 meg/g, or about 1.8 to about 4.0 meg/g, at neutral pH. The one or more anionic monomer unit(s) may be any suitable anionic monomer unit derived from any suitable anionic monomer. In some embodiments, the anionic monomer unit is derived from a monomer selected from 2-acrylamido-2-methylpropane sulfonic acid (“AMPS”), 2-acrylamido-2-methylbutane sulfonic acid (“AMBS”), [2-methyl-2-[(1-oxo-2-propenyl)amino]propyl]-phosphonic acid, methacrylic acid, acrylic acid, salts thereof, and combinations thereof. In certain embodiments, the anionic monomer unit is derived from methacrylic acid and/or acrylic acid. In some embodiments, the anionic monomer unit is derived from acrylic acid.

The polymer backbone can also comprise the one or more monomer unit(s) derived from a monomer of Formula I, the one or more anionic monomer unit(s) and optionally the one or more cationic monomer unit(s) in any suitable proportion such that AGPAM made of the polymer backbone has a charge density in the range of about 1.0 to about 6.0 milliequivalents per gram (meg/g), about 1.5 to about 5.4 meg/g, or about 1.8 15 to about 4.0 meg/g, at neutral pH. The one or more cationic monomer unit(s) may be any suitable cationic monomer unit derived from any suitable cationic monomer. In some embodiments, the cationic monomer unit is derived from a monomer selected from dimethylaminoethyl acrylate methyl chloride quaternary salt (DMAEA.MCQ), dimethyaminoethyl acrylate benzyl chloride quaternary salt, dimethylaminoethyl methacrylate methyl chloride quaternary salt, dimethylaminoethyl methacrylate benzyl chloride quaternary salt, dialkylaminoalkylacrylamides or methacrylamides and their quaternary or acid salts, and diallyldimethyl ammonium chloride (DADMAC), and combinations thereof.

Generally, the polymer backbone has a weight average molecular weight of from about 2 kDa to about 100 kDa. The polymer backbone may also have a weight average molecular weight of about 100 kDa or less, for example, about 80 kDa or less, about 50 kDa or less, about 40 kDa or less, about 30 kDa or less, or about 20 kDa or less. Alternatively, or in addition, the polymer backbone may have a weight average molecular weight of about 2 kDa or more, about 5 kDa or more, about 10 kDa or more, about 15 kDa or more, or about 20 kDa or more. Thus, the polymer backbone may have a weight average molecular weight bounded by any two of the aforementioned endpoints. For example, the polymer backbone may have a weight average molecular weight of from about 2 kDa to about 100 kDa, from about 2 kDa to about 60 kDa, from about 2 kDa to about 50 kDa, from about 2 kDa to about 40 kDa, from about 2 kDa to about 30 kDa, from about 2 kDa to about 20 kDa. Further, the polymer backbone may have a weight average molecular weight of from about 5 kDa to about 100 kDa, from about 5 kDa to about 50 kDa, from about 5 kDa to about 40 kDa, from about 5 kDa to about 30 kDa, or from about 5 kDa to about 25 kDa.

Weight average molecular weight may be determined by any suitable technique. While alternate techniques are envisioned, in some embodiments, the weight average molecular weight is determined using size exclusion chromatography (SEC) equipped with a set of TSKgel PW columns (TSKgel Guard+GMPW+GMPW+G1000 PW), Tosoh Bioscience LLC, Cincinnati, Ohio) and a Waters 2414 (Waters Corporation, Milford, Massachusetts) refractive index detector or a DAWN HELEOS II multi-angle light scattering (MALS) detector (Wyatt Technology, Santa Barbara, California). Moreover, the weight average molecular weight is determined from either calibration with polyethylene oxide/polyethylene glycol standards ranging from 150-875,000 Daltons or directly using light scattering data with known refractive index increment (“dn/dc”).

The polymer backbone is modified with a dialdehyde to form a dialdehyde-modified polymer. As used herein, “dialdehyde-modified” refers to a polymer (e.g., a polyacrylamide copolymer) comprising monomer units that have been modified with a chemical compound containing at least two aldehydes (e.g., two aldehydes). Any suitable monomer unit may be dialdehyde-modified. In an embodiment, for example, acrylamide may be dialdehyde-modified. The dialdehyde may be any suitable chemical compound with at least two aldehydes (e.g., two aldehydes). For example, the dialdehyde may be glyoxal, malondialdehyde, succinic dialdehyde, or glutaraldehyde. In one embodiment, the dialdehyde is glyoxal.

The dialdehyde-modified polymer may have any suitable weight average molecular weight. Generally, the dialdehyde-modified polymer may have a weight average molecular weight of from about 10 kDa to about 10,000 kDa. Further, the dialdehyde-modified polymer may have a weight average molecular weight of may have about 10,000 kDa or less, for example, about 8,000 kDa or less, about 6,000 kDa or less, about 5,000 kDa or less, about 4,000 kDa or less, about 2,000 kDa or less, or about 1,000 kDa or less. Alternatively, or in addition, the dialdehyde-modified polymer may have a weight average molecular weight of about 10 kDa or more, for example, about 100 kDa or more, about 200 kDa or more, about 300 kDa or more, about 400 kDa or more, about 500 kDa or more, or about 750 kDa or more. In further embodiments, the dialdehyde-modified polymer may have a weight average molecular weight bounded by any two of the aforementioned endpoints. For example, the dialdehyde-modified polymer may have a weight average molecular weight of from about 10 kDa to about 10,000 kDa, from about 10 kDa to about 5,000 kDa, from about 100 kDa to about 10,000 kDa, from about 100 kDa to about 5,000 kDa, from about 100 kDa to about 1,000 kDa, from about 100 kDa to about 2,000 kDa, from about 200 kDa to about 1,000 kDa, from about 300 kDa to about 1,000 kDa, from about 400 kDa to about 1,000 kDa, from about 500 kDa to about 1,000 kDa, from about 750 kDa to about 1,000 kDa, from about 750 kDa to about 2,000 kDa, from about 750 kDa to about 4,000 kDa, from about 750 kDa to about 6,000 kDa, from about 750 kDa to about 8,000 kDa, from about 750 kDa to about 10,000 kDa, from about 200 kDa to about 2,000 kDa, or from about 500 kDa to about 2,000 kDa. In certain embodiments, the dialdehyde-modified polymer has a weight average molecular weight of from about 50 kDa to about 3,000 kDa.

The dialdehyde-modified polymer mixture may include any suitable amount of the dialdehyde-modified polymer, referred to as “solids content.” For example, the mixture may include from about 1 wt. % to about 40 wt. % (e.g., from about 1 wt. % to about 30 wt. %, from about 1 wt. % to about 25 wt. %, from about 1 wt. % to about 20 wt. %, from about 1 wt. % to about 15 wt. %, or from about 1 wt. % to about 10 wt. %, from about 2 wt. % to about 30 wt. %, from about 2 wt. % to about 25 wt. %, from about 2 wt. % to about 20 wt. %, from about 2 wt. % to about 15 wt. %, from about 2 wt. % to about 10 wt. %, from about 5 wt. % to about 40 wt. %, from about 5 wt. % to about 30 wt. %, from about 5 wt. % to about 25 wt. %, from about 5 wt. % to about 20 wt. %, from about 5 wt. % to about 15 wt. %, or from about 5 wt. % to about 10 wt. %) solids content. In certain embodiments, the mixture comprises from about 5 wt. % to about 25 wt. % solids content.

In some embodiments, the mixture further comprises or is used with any suitable conventional papermaking product. For example, the mixture further comprises or is used with one or more inorganic filler(s), dye(s), retention aid(s), drainage aid(s), coagulant(s), strength aid(s), or combinations thereof.

In some embodiments, the mixture further comprises or is used with one or more inorganic filler(s). The inorganic filler may be any suitable inorganic filler, capable of increasing opacity or smoothness, decreasing the cost per mass of the paper, or combinations thereof. For example, the mixture further comprises or is used with kaolin, chalk, limestone, talc, titanium dioxide, calcined clay, urea formaldehyde, aluminates, aluminosilicates, silicates, calcium carbonate (e.g., ground and/or precipitated calcium carbonate), or combinations thereof.

In some embodiments, the mixture further comprises or is used with one or more dye(s). The dye may be any suitable dye, capable of controlling the coloration of paper. For example, the dye may be a direct dye, a cationic direct dye, acidic dye, basic dye, insoluble colored pigment, or combinations thereof.

In some embodiments, the mixture further comprises or is used with one or more drainage and/or retention aid(s). The drainage and/or retention aids may be any suitable drainage and/or retention aids, capable of helping to maintain efficiency and drainage of the paper machine, while improving uniformity, and retaining additives. For example, the drainage and/or retention aid may be a cationic polyacrylamide (“PAM”) polymer, an anionic polyacrylamide (“PAM”) polymer, a cationic polyethylenimine (“PEI”) polymer, polyamines, ammonium-based polymers (e.g., polydiallyldimethylammonium chloride (“DADMAC”), colloidal silica, bentonite, polyethylene oxide (“PEO”), starch, polyaluminum sulfate, polyaluminum chloride, or combinations thereof.

In some embodiments, the mixture further comprises or is used with one or more coagulant(s). The coagulant may be any suitable coagulant. As it relates to the present application, “coagulant” refers to a water treatment chemical used in a solid-liquid separation stage to neutralize charges of suspended particles so that the particles can agglomerate. Generally, coagulants may be categorized as cationic, anionic, amphoteric, or zwitterionic. Furthermore, coagulants may be categorized as inorganic coagulants, organic coagulants, and blends thereof. Exemplary inorganic coagulants include, e.g., aluminum or iron salts, such as aluminum sulfate, aluminum chloride, ferric chloride, ferric sulfate, polyaluminum chloride, and/or aluminum chloride hydrate. Exemplary organic coagulants include, e.g., diallyldimethylammonium chloride (“DADMAC”), dialkylaminoalkyl acrylate and/or a dialkylaminoalkyl methacrylate, or their quaternary or acid salts.

In some embodiments, the mixture is used with one or more strength aid(s). The strength aid may be any suitable strength aid. For example, the strength aid can improve dry strength of the paper sheet, wet strength or rewetted strength of the paper sheet, wet web strength of the paper sheet, or a combination thereof. Exemplary strength aids include, e.g., PAE, starch, cationic polyacrylamide (CPAM) polymer, an anionic polyacrylamide (APAM) polymer, a cationic polyethylenimine (PEI) polymer, polyamines, ammonium-based polymers (e.g., polydiallyldimethylammonium chloride (PolyDADMAC) and blends thereof.

The dialdehyde-modified polymer disclosed herein may be prepared using a method comprising: (i) initiating a chemical reaction by treating a polymer backbone with a dialdehyde, wherein the polymer backbone comprises: (a) one or more monomer unit(s) derived from a monomer of Formula I:

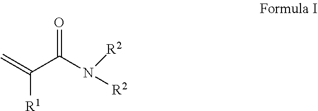

wherein R¹ is H or C₁-C₄ alkyl and each R₂ is independently selected from H or a linear or branched C₁-C₁₀ aliphatic group, (b) about 10 mol % to about 50 mol % of one or more anionic monomer unit(s), (c) optionally about 10 mol % to about 50 mol % one or more cationic monomer unit(s) and (ii) quenching the chemical (e.g., glyoxalation) reaction by adjusting the pH until a pH of from about 4.0 to about 7.0 is reached. As used herein, the phrase “chemical reaction” refers to the interaction between two molecules (e.g., a polymer backbone and a dialdehyde or two polymer backbones comprising dialdehyde modifications). In certain embodiments, the chemical reaction is a glyoxalation reaction.

The dialdehyde-modified polymer disclosed herein may also be prepared using a method comprising initiating a chemical reaction by treating a polymer backbone with a dialdehyde. As used herein, the term “treating” refers to a process of contacting a polymer backbone with a dialdehyde. The polymer backbone and the dialdehyde may be contacted by any suitable method (e.g., pouring, mixing, dropping, etc., or a combination thereof) in any suitable solvent (e.g., water, ethanol, methanol, acetonitrile, etc., or a combination thereof).

The step of initiating a chemical reaction by treating a polymer backbone with a dialdehyde can occur at any suitable pH. Typically, the step of initiating a chemical reaction by treating a polymer backbone with a dialdehyde occurs at a pH of at least about 7.0. For example, the step of initiating a chemical reaction by treating a polymer backbone with a dialdehyde can occur at a pH of from about 7.0 to about 14 (e.g., from about 7.0 to about 13, from about 7.0 to about 12, from about 7.0 to about 11, from about 7.0 to about 10, or from about 7.0 to about 9.0, from about 8.0 to about 12, from about 8.0 to about 11, from about 8.0 to about 10, from about 9.0 to about 14, or from about 9.0 to about 11). In some embodiments, the step of initiating a chemical reaction by treating a polymer backbone with a dialdehyde can occur at a pH of from about 8.0 to about 10. In certain embodiments, the step of initiating a chemical reaction by treating a polymer backbone with a dialdehyde can occur at a pH of about 9.0 to about 9.7.

The dialdehyde-modified polymer disclosed herein may also be prepared using a method comprising a quenching step with an acid, after initiating a chemical reaction by treating a polymer backbone with a dialdehyde. As used herein, the term “quenching” refers to a process of retarding the rate of a chemical (e.g., glyoxalation) reaction such that the degree of dialdehyde modification is substantially slowed or stopped (i.e., the rate of increase of the molecular weight and/or the viscosity is substantially reduced). Typically, the chemical (e.g., glyoxalation) reaction is quenched by adjusting the pH of the reaction mixture until it reaches a pH of from about 4.0 to about 7.0. As used herein, the terms “reach”, “reaches”, or “reaching”, when referring to the quenching pH, means the pH of the reaction mixture when the quenching process is discontinued. Typically, the glyoxalation reaction is quenched with an acid. The acid may be any suitable acid (e.g., hydrochloric acid, sulfuric acid, nitric acid, acetic acid, etc., or a combination thereof) used in any suitable amount such that the pH of the solution resulting from the step of quenching the chemical (e.g., glyoxalation) reaction by adjusting the pH to about 4.0 to about 7.0. In certain embodiments, a suitable base (e.g., triethylamine, sodium hydroxide, potassium hydroxide, sodium bicarbonate, potassium carbonate, etc. or a combination thereof) may be used in combination with an acid to achieve the quenching pH of from about 4.0 to about 7.0.

The step of quenching the chemical (e.g., glyoxalation) reaction by adjusting the pH of the reaction mixture (e.g., the dialdehyde-modified polymer mixture) until reaching a pH of from about 4.0 to about 7.0. For example, the step of quenching the chemical (e.g., glyoxalation) reaction by adjusting the pH of the reaction mixture can occur until reaching a pH of from about 4.0 to about 7.0, or from about 4.5 to 7.0, or from about 5.0 to about 7, or from about 5.5 to about 7.0, or from about 6.0 to about 7.0, e.g., about 4.1 to about 7.0, about 4.2 to about 7.0, about 4.3 to about 7.0, about 4.4 to about 7.0, about 4.5 to about 7.0, about 4.6 to about 7.0, about 4.7 to about 7.0, about 4.8 to about 7.0, about 4.9 to about 7.0, about 5.0 to about 7.0, about 5.1 to about 7.0, about 5.2 to about 7.0, about 5.3 to about 7.0, about 5.4 to about 7.0, about 5.5 to about 7.0, about 6.0 to about 7.0, about 4.5 to about 6.5, about 4.5 to about 6.0, about 4.5 to about 5.5, about 5.0 to about 6.5, about 5.0 to about 5.5, about 5.5 to about 6.5, or about 5.5 to about 6.0. In certain embodiments, the step of quenching the chemical (e.g., glyoxalation) reaction by adjusting the pH of the reaction mixture (e.g., the dialdehyde-modified polymer mixture) until reaching a pH of from about 4.5 to about 7.0. In other embodiments, the step of quenching the chemical (e.g., glyoxalation) reaction by adjusting the pH of the reaction mixture (e.g., the dialdehyde-modified polymer mixture) until reaching a pH of from about 5.0 to about 7.0.

A method of enhancing paper strength properties is also provided. The method comprises treating a paper sheet precursor with a dialdehyde-modified polymer(s) or mixture(s) described herein.

The method of enhancing paper strength properties comprises treating a paper sheet at any suitable pH. Generally, the overall treatment may have a pH of from about 4.0 or more, e.g., about 4.5 or more, about 5.0 or more, about 5.5 or more, about 6.0 or more, about 6.5 or more, about 7.0 or more, about 7.5 or more, about 8.0 or more, or about 8.5 or more. Alternatively, or in addition, the treatment may have a pH of about 11 or less, e.g., about 10.5 or less, about 10 or less, about 9.5 or less, or about 9.0 or less. Thus, the treatment may have a pH bounded by any two of the above endpoints recited. For example, the treatment may have a pH of from about 4.0 to about 11.0, from about 5.0 to about 11.0, from about 6.0 to about 11.0, from about 7.0 to about 11.0, or from about 8.0 to about 11.0. For example, the treatment may have a pH of about 4.5 to about 9.0, e.g., from about 5.0 to about 9.0, from about 5.5 to about 9.0, from about 6.0 to about 9.0, from about 6.5 to about 9.0, from about 7.0 to about 9.0, from about 7.5 to about 9.0, from about 8.0 to about 9.0, from about 8.5 to about 9.0, from about 8.5 to about 11, from about 8.5 to about 10.5, from about 8.5 to about 10, from about 8.5 to about 9.5, from about 8.5 to about 9.0, from about 4.0 to about 11, from about 7.0 to about 10, or about 8.0.

The dialdehyde-modified polymer or dialdehyde-modified polymer mixture disclosed herein may be added to any suitable paper sheet precursor. As used herein, the term “paper sheet precursor” refers to any component of the papermaking process upstream of the point at which the fiber slurry begins being rolled into a paper sheet. Accordingly, the dialdehyde-modified polymer or dialdehyde-modified polymer mixture may be added to pulp (e.g., virgin pulp, recycled pulp, or a combination thereof), pulp slurry, cellulosic fibers, a solution used for any of the aforementioned components, and any combination thereof. The dialdehyde-modified polymer or dialdehyde-modified polymer mixture may be added to the paper sheet precursor at any one or more of various locations during the papermaking process, up to and including a headbox. In some embodiments, the dialdehyde-modified polymer or dialdehyde-modified polymer mixture may be added to the pulp slurry in a pulper, latency chest, reject refiner chest, disk filter or Decker feed or accept, whitewater system, pulp stock storage chests (either low density (“LD”), medium consistency (“MC”), or high consistency (“HC”)), blend chest, machine chest, headbox, save-all chest, paper machine whitewater system, or combinations thereof. In certain embodiments, the dialdehyde-modified polymer or dialdehyde-modified polymer mixture is added to the headbox.

In some embodiments, the dialdehyde-modified polymer or dialdehyde-modified polymer mixture is stored in the absence of fiber and added to the paper sheet precursor upstream of a wet end of a paper machine (e.g., before the wet end). As used herein, the term “wet end” refers to any component of the papermaking process including the headbox and downstream thereof. Accordingly, the dialdehyde-modified polymer or dialdehyde-modified polymer mixture may be added to any component of the papermaking process up to but not including the headbox. In certain embodiments, the dialdehyde-modified polymer or dialdehyde-modified polymer mixture is added to a stock prep section of the paper machine. As used herein, “stock prep section” refers to any component of the papermaking process wherein the pulp is refined and/or blended. For example, the dialdehyde-modified polymer or dialdehyde-modified polymer mixture may be added to the pulp stock storage chests, blend chest, machine chest, save-all chest, or a combination thereof. In certain embodiments, the dialdehyde-modified polymer or dialdehyde-modified polymer mixture is added to pulp slurry upstream of a head box of a papermaking process.

In some embodiments, the pulp slurry comprises recycled fibers. The recycled fibers may be obtained from a variety of paper products or fiber containing products, such as paperboard, newsprint, printing grades, sanitary or other paper products. In some embodiments, these products can comprise, for example, old corrugated cardboard (OCC), old newsprint (ONP), mixed office waste (MOW), magazines, books, or a combination thereof. In some embodiments, the pulp slurry comprises virgin fibers. In embodiments comprising virgin fibers, the pulp may be derived from softwood, hardwood, or blends thereof. In certain embodiments, the virgin pulp can include bleached or unbleached Kraft, sulfite pulp or other chemical pulps, and groundwood (GW) or other mechanical pulps such as, for example, thermomechanical pulp (TMP).

The method of enhancing paper strength properties may enhance any suitable paper strength property. For example, treatment according to the methods described herein can, for example, allow for increased ash content in the finished paper, boost strength properties of the finished paper, increase retention during the papermaking process, and improve dewatering efficiency during the papermaking process.

### Embodiments

A non-limiting list of embodiments is provided below:
1. A paper strength additive composition, said composition comprising: an anionic dialdehyde-modified polymeric dry strength resin and a cationic wet strength resin, wherein said anionic dry strength resin has a charge density in the range of about 1.0 to about 6.0 meg/g, about 1.5 to about 5.4 meg/g, or about 1.8 to about 4.0 meg/g, at neutral pH.
2. The composition of embodiment 1, wherein said anionic dry strength resin is a dialdehyde-modified polymer mixture comprising a solvent and a dialdehyde modified polymer comprising:
   a polymer backbone comprising:
      i. one or more monomer unit(s) derived from a monomer of Formula I:

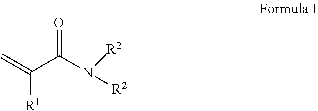

wherein R¹ is H or C₁-C₄ alkyl and each R₂ is independently selected from H or a linear or branched C₁-C₁₀ aliphatic group, and
   i. About 3 mol % to about 50 mol % of one or more anionic monomer unit(s)
      ii. optionally about 3 mol % to about 50 mol % of one or more cationic monomer unit(s).
3. The composition of embodiment 2, wherein the one or more anionic monomer unit(s) is derived from a monomer selected from 2-acrylamido-2-methylpropane sulfonic acid (“AMPS”), 2-acrylamido-2-methylbutane sulfonic acid (“AMBS”), [2-methyl-2-[(1-oxo-2-propenyl)amino]propyl]-phosphonic acid, methacrylic acid, acrylic acid, salts thereof, and combinations thereof.
4. The composition of embodiment 2, wherein the one or more anionic monomer unit(s) is derived from acrylic acid.
5. The composition of embodiment 2, wherein the monomer of Formula I is acrylamide, methacrylamide, ethylacrylamide, N-methyl acrylamide, N-butyl acrylamide, or any combination thereof.
6. The composition of embodiment 2, wherein the monomer of Formula I is acrylamide.
7. The composition of embodiment 2, wherein the monomer of cationic unit(s) is derived from a monomer selected from dimethylaminoethyl acrylate methyl chloride quaternary slat (DMAEA.MCQ), dimethylaminoethyl acrylate benzyl chloride quaternary salt, dimethylaminoethyl methacrylate benzyl chloride quaternary salt, dialkyldimethyl ammonium chloride (DADMAC), and combinations thereof.
8. The composition of embodiment 2, wherein the dialdehyde-modified polymer is modified with a dialdehyde selected from glyoxal, malondialdehyde, succinic dialdehyde, and glutaraldehyde.
9. The composition of embodiment 2, wherein the dialdehyde is glyoxal.
10. The composition of embodiment 2, wherein the dialdehyde modified polymer has an anionic charge density in the range of about 1.5 to about 5.4 meg/g at neutral pH.
11. The composition of embodiment 2, wherein the dialdehyde modified polymer has an anionic charge density in the range of about 1.8 to about 4.0 meg/g at neutral pH.
12. The composition of embodiment 2, wherein the dialdehyde-modified polymer has a weight average molecular weight in the range of about 50 kDa to about 3,000 kDa.
13. The composition of embodiment 2, wherein the dialdehyde-modified polymer has a weight average molecular weight in the range of about 100 kDa to about 2,000 kDa.
14. The composition of embodiment 2, wherein the polymer backbone has a weight average molecular weight in the range of about 2 kDa to about 100 kDa in the absence of the dialdehyde modification.
15. The composition of embodiment 2, wherein the polymer backbone has a weight average molecular weight in the range of about 5 kDa to about 25 kDa in the absence of the dialdehyde modification.
16. The composition of embodiment 2, wherein the dialdehyde-modified polymer mixture has a solids content in the range of about 1 wt. % to about 40 wt. %.
17. The composition of embodiment 2, wherein the dialdehyde-modified polymer mixture has a solids content in the range of about 5 wt. % to about 25 wt. %.
18. The composition of any of any of the preceding embodiments, wherein the dialdehyde-modified polymer mixture is an AGPAM.
19. The composition of embodiment 1, wherein said cationic wet strength resin is either a temporary wet strength resin like GPAM or a permanent wet strength resin like PAE, urea-formaldehyde resin, melamine-formaldehyde resin, polyamines and polyethylene imides epichlorohydrin, or hydrolyzed N-vinylformamide.
20. The composition of embodiment 18, wherein said temporary wet strength resin is GPAM.
21. The composition of embodiment 18, wherein said permanent wet strength resin is chosen from PAE, urea-formaldehyde resin, melamine-formaldehyde resin, polyamine and polyethylene imide epichlorohydrin, or hydrolyzed N-vinylformamide.
22. The composition of embodiment 1, wherein said cationic wet strength resin is a PAE.
23. A paper strength additive composition, said composition comprising a PAE resin and an AGPAM.
24. A method of increasing the strength of tissue paper or towel paper, said method comprising contacting a composition according to any of the preceding embodiments with fiber during the towel papermaking process.
25. The method of embodiment 22, wherein said composition is added to thin stock, thick stock, the headbox, before the headbox, after the headbox, or before a press section, and any combination thereof.
26. A method of increasing the strength of tissue paper or towel paper, said method comprising contacting an anionic dialdehyde-modified polymeric dry strength resin with a charge density in the range of about 1.0 to about 6.0 meg/g at neutral pH and a cationic wet strength resin, with fiber during the towel papermaking process.
27. The method of embodiment 25, wherein said contacting comprises adding said cationic wet strength resin to water during the towel paper making process and adding said anionic dialdehyde-modified polymeric dry strength resin composition to water during towel paper making process.
28. The method of embodiment 27, wherein said water is present in a thin stock, a thick stock, and/or in the headbox in a papermaking machine.
29. The method of embodiment 25, wherein said contacting comprises adding said cationic wet strength resin to water during the towel paper making process and adding said anionic dialdehyde-modified polymeric dry strength resin composition to thin stock, thick stock, the headbox, before the headbox, after the headbox, or before a press section, and any combination thereof.
30. The method of embodiment 25, wherein said contacting comprises adding a cationic wet strength resin to towel paper making process water and adding an anionic dialdehyde-modified polymeric dry strength resin to the towel paper making process water.
31. The method of embodiment 25, wherein said contacting comprises first adding said cationic wet strength resin to water during the towel paper making process and adding said anionic dialdehyde-modified polymeric dry strength resin at a later time.
32. The method of embodiment 25, wherein said contacting comprises co-feeding said cationic wet strength resin and said anionic dialdehyde-modified polymeric dry strength resin in the towel paper making process.
33. The method of embodiment 25, wherein said contacting comprises adding in the range of about 0.1 lb/ton to about 100 lb/ton of said cationic wet strength resin, relative to solid fiber, to stock during a towel making process.
34. The method of embodiment 25, wherein said contacting comprises adding in the range of about 0.1 lb/ton to about 100 lb/ton of said anionic dialdehyde-modified polymeric dry strength resin, relative to solid fiber, to stock during a towel making process.
35. The method of embodiment 25, wherein said anionic dialdehyde-modified polymeric dry strength resin comprises a polymer backbone comprising:
   i. one or more monomer unit(s) derived from a monomer of Formula I:

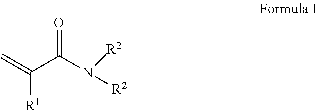

wherein R¹ is H or C₁-C₄ alkyl and each R₂ is independently selected from H or a linear or branched C₁-C₁₀ aliphatic group, and
   ii. about 3 mol % to about 50 mol % of one or more anionic monomer unit(s); and
   iii. optionally 3 mol % to about 50 mol % of one or more cationic monomer unit(s).
36. The method of embodiment 34, wherein the one or more anionic monomer unit(s) is derived from a monomer selected from 2-acrylamido-2-methylpropane sulfonic acid (“AMPS”), 2-acrylamido-2-methylbutane sulfonic acid (“AMBS”), [2-methyl-2-[(1-oxo-2-propenyl)amino]propyl]-phosphonic acid, methacrylic acid, acrylic acid, salts thereof, and combinations thereof.
37. The method of embodiment 34, wherein the one or more anionic monomer unit(s) is derived from acrylic acid.
38. The method of embodiment 34, wherein the monomer of Formula I is acrylamide, methacrylamide, ethylacrylamide, N-methyl acrylamide, or N-butyl acrylamide, and any combination thereof.
39. The method of embodiment 34, wherein the monomer of Formula I is acrylamide.
40. The method of embodiment 34, wherein the one or more cationic monomer unit(s) is derived from a monomer selected from dimethylaminoethyl acrylate methyl chloride quaternary slat (DMAEA.MCQ), dimethylaminoethyl acrylate benzyl chloride quaternary salt, dimethylaminoethyl methacrylate benzyl chloride quaternary salt, dialkyldimethyl ammonium chloride (DADMAC), and combinations thereof.
41. The method of embodiment 34, wherein the dialdehyde-modified polymer is modified with a dialdehyde selected from glyoxal, malondialdehyde, succinic dialdehyde, and glutaraldehyde.
42. The method of embodiment 39, wherein the dialdehyde is glyoxal.
43. The method of any of any of the preceding embodiments, wherein the anionic dialdehyde modified polymer has a charge density in the range of about 1.5 to about 5.4 meg/g at neutral pH.
44. The method of any of any of the preceding embodiments, wherein the anionic dialdehyde modified polymer has a charge density in the range of about 1.8 to about 4.0 meg/g at neutral pH.
45. The method of any of the preceding embodiments, wherein the dialdehyde-modified polymer has a weight average molecular weight in the range of about 50 kDa to about 3,000 kDa.
46. The method of any of any of the preceding embodiments, wherein the dialdehyde-modified polymer has a weight average molecular weight in the range of about 100 kDa to about 2,000 kDa.
47. The method of any of any of the preceding embodiments, wherein the polymer backbone has a weight average molecular weight in the range of about 2 kDa to about 100 kDa in the absence of the dialdehyde modification.
48. The method of any of any of the preceding embodiments, wherein the polymer backbone has a weight average molecular weight in the range of about 5 kDa to about 25 kDa in the absence of the dialdehyde modification.
49. The method of any of any of the preceding embodiments, wherein the dialdehyde-modified polymer mixture has a solids content in the range of about 1 wt. % to about 40 wt. %.
50. The method of any of any of the preceding embodiments, wherein the dialdehyde-modified polymer mixture has a solids content in the range of about 5 wt. % to about 25 wt. %.
51. The method of any of any of the preceding embodiments, wherein the dialdehyde-modified polymer mixture is an AGPAM.
52. The method of any of any of the preceding embodiments, wherein said cationic wet strength resin is a temporary wet strength resin, a permanent wet strength resin, or a combination thereof.
53. The method of any of any of the preceding embodiments, wherein said temporary wet strength resin is GPAM.
54. The method of any of any of the preceding embodiments, wherein said permanent wet strength resin is chosen from PAE, Urea-formaldehyde resin, melamine-formaldehyde resin, polyamines and polyethylene imides epichlorohydrin, or hydrolyzed N-vinylformamide.
55. The method of any of any of the preceding embodiments, wherein said wet strength resin is a PAE.
56. The method of any of any of the preceding embodiments, wherein said anionic dry strength resin is an AGPAM.
57. The method of any of any of the preceding embodiments, wherein said wet strength resin is PAE.
58. The method of any of the preceding embodiments, wherein said method involves increasing the wet strength and/or dry strength of tissue paper and/or towel paper.
59. A composition, said composition comprising an anionic dialdehyde-modified polymeric dry strength resin, a cationic wet strength resin, and fiber, wherein said anionic dry strength resin has a charge density in the range of about 1.0 to about 6.0 meg/g, about 1.5 to about 5.4 meg/g, or about 1.8 to about 4.0 meg/g, at neutral pH.
60. A paper making slurry comprising an anionic dialdehyde-modified polymeric dry strength resin, a cationic wet strength resin, water, and pulp fibers, wherein the slurry has a consistency in the range of about 0.05% to about 0.2%, or has a consistency of about 0.1%, and wherein said anionic dry strength resin has a charge density in the range of about 1.0 to about 6.0 meg/g, about 1.5 to about 5.4 meg/g, or about 1.8 to about 4.0 meg/g, at neutral pH.
61. A paper product (e.g., tissue paper, towel paper, etc.), said product comprising fiber, an anionic dialdehyde-modified polymeric dry strength resin, and a cationic wet strength resin, wherein said anionic dry strength resin has a charge density in the range of about 1.0 to about 6.0 meg/g, about 1.5 to about 5.4 meg/g, or about 1.8 to about 4.0 meg/g, at neutral pH, and wherein said product has a basis weight in the range of about 8 g/m² to 40 g/m², or in the range of about 15 g/m² to about 25 g/m², or has a basis weight of about 20 g/m².
62. The method of any of the preceding embodiments, wherein said fiber is a wood fiber, a non-wood (alternative/agricultural/residue) fiber, or a recycle fiber.
63. The method of any of the preceding embodiments, wherein said wood fiber comprises fibers from hardwood/deciduous trees (e.g., eucalyptus, maple, birch, aspen, etc.) or fibers from softwood/coniferous trees (e.g., spruce, pine, fir, hemlock, etc.).
64. The method of any of the preceding embodiments, wherein said non-wood wood (alternative/agricultural/residue) fiber comprises fibers from e.g., bamboo, bagasse, wheat straw, hemp, esparto, switchgrass, sorghum, miscanthus, etc.
65. The method of any of the preceding embodiments, wherein said recycle fiber comprises fibers from graphic papers (e.g., mixed office waste, old newspapers, etc.) or from boards and packages (e.g., old-corrugated containers, etc.).
66. The composition of any of the preceding embodiments, wherein said fiber is a wood fiber, a non-wood (alternative/agricultural/residue) fiber, or a recycle fiber.
67. The composition of any of the preceding embodiments, wherein said wood fiber comprises fibers from hardwood/deciduous trees (e.g., eucalyptus, maple, birch, aspen, etc.) or fibers from softwood/coniferous trees (e.g., spruce, pine, fir, hemlock, etc.).
68. The composition of any of the preceding embodiments, wherein said non-wood wood (alternative/agricultural/residue) fiber comprises fibers from e.g., bamboo, bagasse, wheat straw, hemp, esparto, switchgrass, sorghum, miscanthus, etc.
69. The composition of any of the preceding embodiments, wherein said recycle fiber comprises fibers from graphic papers (e.g., mixed office waste, old newspapers, etc.) or from boards and packages (e.g., old-corrugated containers, etc.).
70. The slurry of any of the preceding embodiments, wherein said fiber is a wood fiber, a non-wood (alternative/agricultural/residue) fiber, or a recycle fiber.
71. The slurry of any of the preceding embodiments, wherein said wood fiber comprises fibers from hardwood/deciduous trees (e.g., eucalyptus, maple, birch, aspen, etc.) or fibers from softwood/coniferous trees (e.g., spruce, pine, fir, hemlock, etc.).
72. The slurry of any of the preceding embodiments, wherein said non-wood wood (alternative/agricultural/residue) fiber comprises fibers from e.g., bamboo, bagasse, wheat straw, hemp, esparto, switchgrass, sorghum, miscanthus, etc.
73. The slurry of any of the preceding embodiments, wherein said recycle fiber comprises fibers from graphic papers (e.g., mixed office waste, old newspapers, etc.) or from boards and packages (e.g., old corrugated containers, etc.).
74. The paper product of any of the preceding embodiments, wherein said fiber is a wood fiber, a non-wood (alternative/agricultural/residue) fiber, or a recycle fiber.
75. The paper product of any of the preceding embodiments, wherein said wood fiber comprises fibers from hardwood/deciduous trees (e.g., eucalyptus, maple, birch, aspen, etc.) or fibers from softwood/coniferous trees (e.g., spruce, pine, fir, hemlock, etc.).
76. The paper product of any of the preceding embodiments, wherein said non-wood wood (alternative/agricultural/residue) fiber comprises fibers from e.g., bamboo, bagasse, wheat straw, hemp, esparto, switchgrass, sorghum, miscanthus, etc.
77. The paper product of any of the preceding embodiments, wherein said recycle fiber comprises fibers from graphic papers (e.g., mixed office waste, old newspapers, etc.) or from boards and packages (e.g., old corrugated containers, etc.).

### EXAMPLES

The foregoing may be better understood by reference to the following examples, which are presented for purposes of illustration and are not intended to limit the scope of the invention.

### Example 1 AGPAM Synthesis and Characterization

### (1) Synthesis of Polyacrylamide Base Polymer 1 (Backbone-1)

To a 1 L reaction flask equipped with a mechanical stirrer, thermocouple, condenser, nitrogen purge tube, and addition port, 230.58 g of water, 0.1 g of EDTA, and 3.5 g of sodium formate were added. The mixture was then purged with N₂ and heated to reflux. Upon reaching the desired temperature (˜95-100° C.), 17.6 g of a 25% aqueous solution of ammonium persulfate (APS) was added over a period of 130 minutes. Two minutes after starting the initiator solution addition, a monomer mixture containing 690.36 g of 49.5% acrylamide, 18.26 g of acrylic acid, 30 g of water, 7 g of sodium hypophosphite, and 1.6 g of 50% sodium hydroxide was added to the reaction mixture over a period of 115 minutes. The reaction was held at reflux for an additional hour after APS addition. The mixture was then cooled to room temperature providing the base polymer 1 as 36% actives, viscous and clear to yellow solution. It had a molecular weight of about 7,400-8500 Dalton.

### (2) Synthesis of Polyacrylamide Base Polymer 2 (Backbone-2)

To a 1 L reaction flask equipped with a mechanical stirrer, thermocouple, condenser, nitrogen purge tube, and addition port, 236.08 g of water, 0.15 g of EDTA, and 4 g of sodium formate were added. The mixture was then purged with N₂ and heated 90° C. (+2° C.). Upon reaching the desired temperature, 22 g of a 20% aqueous solution of ammonium persulfate (APS) was added over a period of ˜137 minutes. Two minutes after starting the initiator solution addition, a monomer mixture containing 600.01 g of 49.5% acrylamide, 53.05 g of acrylic acid, 53.19 g of water, 6.7 g of sodium hypophosphite, and 5.72 g of 50% sodium hydroxide was added to the reaction mixture over a period of ˜120 minutes. The reaction was held at reflux for an additional hour after APS addition. The mixture was then cooled to room temperature providing the base polymer 2 as 35% actives, viscous and clear to yellow solution. It had a molecular weight of about 8,400 Dalton.

### (3) Synthesis of Polyacrylamide Base Polymer 3 (Backbone-3)

To a 1 L reaction flask equipped with a mechanical stirrer, thermocouple, condenser, nitrogen purge tube, and addition port, 230.88 g of water, 0.15 g of EDTA, and 4 g of sodium formate (R-1633) were added. The mixture was then purged with N₂ and heated to reflux. Upon reaching the desired temperature (˜95-100° C.), 17.6 g of a 25% aqueous solution of ammonium persulfate (APS) was added over a period of 137 minutes. Two minutes after starting the APS initiator addition, a monomer mixture containing 563.96 g of 49.5% acrylamide, 70.61 g of acrylic acid, 90 g of water, 6.7 g of sodium hypophosphite (R-3344), and 5.7 g of 50% sodium hydroxide was added to the reaction mixture over a period of 120 minutes. A post-treat APS solution (5 g, 25%) was added over ˜5 minutes, then the reaction mixture was held at reflux for an additional hour. The mixture was cooled to room temperature providing the base polymer 3 as 35% active, viscous, and clear to amber solution. It had a molecular weight of about 8000-9,000 Daltons.

### (4) Synthesis of Polyacrylamide Base Polymer 4 (Backbone-4)

To a 1 L reaction flask equipped with a mechanical stirrer, thermocouple, condenser, nitrogen purge tube, and addition port, 236.04 g of water, 0.15 g of ethylenediaminetetraacetic acid (EDTA), and 4 g of sodium formate were added. The mixture was then purged with N₂ and heated to 90° C. (±2° C.). Upon reaching the desired temperature, 22 g of a 20% aqueous solution of ammonium persulfate (APS) was added over a period of ˜137 minutes. Two minutes after starting the initiator solution addition, a monomer mixture containing 499.37 g of 49.5% acrylamide, 105.88 g of acrylic acid, 120 g of water, 6.7 g of sodium hypophosphite, and 5.7 g of 50% sodium hydroxide was added to the reaction mixture over a period of ˜120 minutes. The reaction was held at reflux for an additional hour after APS addition. The mixture was then cooled to room temperature providing the base polymer 4 as 35% actives, viscous and clear to yellow solution. It had a molecular weight of about 9,400 Dalton.

### (5) Synthesis of Anionic Glyoxylated Polyacrylamide Copolymer 1 (AGPAM-1)

The Backbone-1 (77.15 g) and water (358.49 g) were charged into a 500 mL tall beaker at room temperature. The pH of the polymer solution was adjusted to 8.9-9.2 using 1.8 g of 50% aqueous sodium hydroxide solution. The reaction temperature was set to 24-26° C. Glyoxal (21.75 g of a 40% aqueous solution) was added over 15-45 minutes. The pH of the resulting solution was then adjusted to 9-9.5 using 10% sodium hydroxide solution (4.5 g). The Brookfield viscosity (Brookfield Programmable DV-E Viscometer, #1 spindle @ 60 rpm, Brookfield Engineering Laboratories, Inc., Middleboro, Mass.) of the mixture was about 3-4 cps after sodium hydroxide addition. The pH of the reaction mixture was maintained at about 8.5 to 9.5 at about 24-26° C. with good mixing (more 10% sodium hydroxide solution can be added if necessary). The Brookfield viscosity (BFV) was measured and monitored every 15-45 minutes and upon achieving the desired viscosity increase of greater than or equal to 1 cps (4 to 200 cps, >100,000 g/mole) the pH of the reaction mixture was decreased to 4.7-5.3 by adding sulfuric acid (93%). The product was a clear to hazy, colorless to amber, fluid with a BFV greater than or equal to 4 cps. The resulting product was more stable upon storage when BFV of the product was less than 40 cps, and when the product was diluted to lower actives. The product can be prepared at higher or lower percent total actives by adjusting the desired target product viscosity. For AGPAM-1, it has molecular weight of 1.1 million Dalton, and charge density of 1.28 meg/g.

### (6) Synthesis of Anionic Glyoxylated Polyacrylamide Copolymer 2 (AGPAM-2)

AGPAM-2 was synthesized following similar process as described for AGPAM-1 except that Backbone-2 was used. The final product has molecular weight of about 450,000 Dalton and charge density of 1.91 meg/g.

### (7) Synthesis of Anionic Glyoxylated Polyacrylamide Copolymer 3 (AGPAM-3)

AGPAM-3 was synthesized following similar process as described for AGPAM-1 except that Backbone-3 was used. The final product has molecular weight of about 760,000 Dalton and charge density of 3.54 meg/g.

### (8) Synthesis of Anionic Glyoxylated Polyacrylamide Copolymer 4 (AGPAM-4)

AGPAM-4 was synthesized following similar process as described for AGPAM-1 except that Backbone-4 was used. The final product has molecular weight of about 195,000 Dalton and charge density of 4.20 meg/g.

TABLE 1
Molecular characteristics of representative backbone

| | Mole % | Mw | Total |
|---|---|---|---|
| Sample ID | AA | (Da) | solids % |
| Backone-1 | 5 | 7,400-8500 | 36 |
| Backbone-2 | 15 | 8,400 | 35 |
| Backbone-3 | 20 | 8,000-9,000 | 35 |
| Backbone-4 | 30 | 9,400 | 35 |

TABLE 2
Properties of synthesized AGPAMs

| | | Mono- | Di- | | Mono- | Di- | | Polymer charge |
|---|---|---|---|---|---|---|---|---|
| | Unreacted | reacted | reacted | Unreacted | reacted | reacted | Mw | density at pH |
| Sample ID | glyoxal | glyoxal | glyoxal | AcAm | AcAm | AcAm | (kDa) | neutral (meg/g) |
| AGPAM-1 | 45% | 35% | 20% | 73% | 13% | 14% | 1,100 | 1.28 |
| AGPAM-2 | 55% | 33% | 12% | 56% | 26% | 18% | 450 | 1.91 |
| AGPAM-3 | 57% | 27% | 16% | 54% | 23% | 23% | 760 | 3.54 |
| AGPAM-4 | 58% | 29% | 13% | 61% | 20% | 19% | 195 | 4.20 |

### Example 2 Method of Lab Handsheet Preparation and Testing

The pulp slurry (thick stock) is obtained from a paper mill. The thick stock comprises a mixed slurry of softwood bleached kraft pulp and hardwood bleached kraft pulp, or other pulp, as main components. Sheet-making is performed after the thick stock is diluted with mill white water from paper-making plant to a consistency of about 0.5%.

A Noble and Wood handsheet mold is used to make lab sheets. The specific test method is described in the Technical Association of the Pulp and Paper Industry's (TAPPI) T205 Introduction sp-02. To the diluted pulp, testing additives are added successively at a rotation speed of about 800 rpm for 15 seconds for each chemical additive. The pulp with the chemical additives is then poured into the forming cylinder of the handsheets making mold and undergoes filtering and forming. The 8″×8″ handsheet is formed by drainage through a 100-mesh forming wire. The handsheet is couched from the sheet mold wire by placing two blotters and a metal plate on the wet handsheet and roll-pressing with six passes of a 25-1b metal roller. The forming wire and one blotter are removed and the handsheet is placed between two new blotters and a metal plate. Then the sheet was pressed at 5.65 MPa under a static press for five minutes. All of the blotters are removed and the handsheet is dried for 60 seconds (metal plate side facing the dryer surface) using a rotary drum drier set at 220° F. The average basis weight of a handsheet is 60 g/m². The handsheet mold, static press, and rotary drum dryer are available from Adirondack Machine Company, Queensbury, N.Y. Five replicate handsheets are produced for each condition.

The finished handsheets are stored overnight at TAPPI standard conditions of 50% relative humidity and 23° C. The basis weight is analyzed on a standard balance and calculated in g/m². Caliper is measured at five points over the surface of the sheet using an Emveco 200A electronic microgage. These values are averaged out and the sheet density is calculated by dividing the basis weight over the average caliper.

Tensile Index is measured with a Thwing-Albert EJA Vantage tensile tester running MAP software. The gauge length is 10-cm and the strip is pulled at 2.54 cm/min. The script used for dry tensile testing recognizes a break in the strip when the load cell reading decreases 65% from the maximum observed value. Wet Tensile Index is measured using the same instrument, gauge length, and movement rate as for dry tensile. The strip is wetted with DI water by carefully touching the strip with a wet brush for 30 seconds. After 30 seconds the brush is removed, and the tensile test is started. The wet tensile recognizes a break when the load cell reading decreases by 1 N from the maximum observed value.

### Example 3. Lab Performance

The following examples either compare the strength boost or dosage reduction of a composition of the present disclosure with other industrially relevant chemical compositions from the addition of a wet strength resin to a given furnish composition. It is hypothesized that compositions of the present disclosure have the effect of bolstering both the dry and wet strength of the furnish compositions as compared to the other industrially relevant chemical compositions tested hereby.

(1)

The representative compositions of the present disclosure are summarized in Table 2. The industrially relevant chemicals used in laboratory studies are as follows: PAE, CMC, and APAM. This is summarized in Table 3.

TABLE 3
Representative chemicals used in lab studies

| | | | polymer charge |
|---|---|---|---|
| | | Mw | density meg/g @ |
| Sample ID | Chemistry | (KDa) | neutral pH |
| CMC | Sodium carboxymethyl | 250 to 700 | 5.42 |
| | cellulose, 1.0 DS, | | |
| PAE | polyaminoamide- | 400 to 600 | 1.97 |
| | epichlorohydrin | | |
| APAM | polyacrylate-acrylamide | 500 | 3.97 |
| | copolymer | | |
| AGPAM-1 | glyoxylated polyacrylate- | 1,100 | 1.28 |
| | acrylamide copolymer | | |
| AGPAM-2 | glyoxylated polyacrylate- | 450 | 1.91 |
| | acrylamide copolymer | | |
| AGPAM-3 | glyoxylated polyacrylate- | 760 | 3.54 |
| | acrylamide copolymer | | |
| AGPAM-4 | glyoxylated polyacrylate- | 196 | 4.20 |
| | acrylamide copolymer | | |

(2) Comparison of AGPAM with CMC

AGPAM of the present disclosure were tested against CMC for a comparison of strength gain of lab handsheets to a furnish composition without any chemical treatment. To make the handsheets, the PAE resin solution and anionic dry strength resin were respectively diluted to target concentration less than 1% with ionized water. The diluted PAE resin solution and anionic dry strength resin solution were then added into the 0.5 wt % furnish in sequence. The interval of adding the components was about 15 s. The lab handsheets of the invention were prepared according to the handsheet preparation method as described above. The thick stock used in this Example was a mixed slurry of 46% bleached softwood kraft (SWK), 17% bleached hardwood kraft (HWK), and 37% broke. The dosage of PAE in this Example is 0.335 wt % and 0.419 wt %, CMC is 0.29 wt %, and AGPAM-3 is 0.0725 wt % and 0.29 wt %. It should be noted that the dosage of the tested additive herein refers to the amount of the active ingredient in the solution relative to the dry fiber in the pulp slurry. The meaning of dosage also applies to the following examples.

TABLE 3
Composition and dosage of paper-making chemical
additives and measured sheet strength properties.

| | | | Dry | Dry | | Wet | Wet | |
|---|---|---|---|---|---|---|---|---|
| | Dosage | Dosage | Tensile | Tensile | % gain | Tensile | Tensile | % gain |
| | of WSR | of DSR | Index | Index | from | Index | Index | from |
| Conditions | (wt %) | (wt %) | (N*m/g) | 95% CI | blank | (N*m/g) | 95% CI | blank |
| Blank | 0 | 0 | 61.3 | 3.8 | 0% | 3.0 | 0.19 | 0% |
| PAE (1) | 0.335 | 0 | 72.7 | 2.2 | 19% | 14.5 | 1.15 | 375% |
| PAE (1) + CMC | 0.335 | 0.29 | 77.2 | 4.1 | 26% | 13.9 | 0.81 | 355% |
| PAE (1) + AGPAM-3 | 0.335 | 0.0725 | 81.1 | 1.9 | 32% | 16.3 | 0.90 | 435% |
| PAE (1) + AGPAM-3 | 0.335 | 0.29 | 85.7 | 4.2 | 40% | 17.4 | 1.19 | 472% |
| PAE (2) | 0.419 | 0 | 74.2 | 3.2 | 21% | 15.8 | 0.75 | 418% |
| PAE (2) + CMC | 0.419 | 0.29 | 74.3 | 2.9 | 21% | 15.3 | 0.74 | 402% |
| PAE (2) + AGPAM-3 | 0.419 | 0.29 | 82.0 | 2.3 | 34% | 19.4 | 0.83 | 536% |

As seen from Table 3, the use of a combination of PAE resin and AGPAM-3 at 25% of CMC dosage according to the present invention as the strength agents results in much higher dry tensile gain (26% by CMC vs 32% by AGPAM-3) and wet tensile gain (355% by CMC vs 435% by AGPAM-3) than the combination of PAE resin and CMC. Even higher tensile strength gain is achieved when use equal dosage of AGPAM-3 to CMC. This excessive strength gain, both in dry and wet strength suggests that the dosage of the strength additives, especially the dosage of PAE resin, can be significantly reduced by using the paper-making aid according to the present invention as the strength additives. It can also lead to refining reduction or fiber substitution.

(3) Comparison with APAM

AGPAM of the present disclosure were also tested against APAM for a comparison of the strength gain of lab handsheets to a furnish composition without any chemical treatment. The handsheets making process is similar to the above case. The thick stock used in this Example was a mixed slurry of 60% bleached softwood kraft (SWK) and 40% bleached hardwood kraft (HWK). The dosage of PAE in this Example is 0.225 wt %, APAM is 0.1 wt % and 0.2 wt %, and AGPAM-3 is 0.1 wt %.

TABLE 4
Composition and dosage of paper-making chemical
additives and measured sheet strength properties.

| | | | Dry | | | Wet | | |
|---|---|---|---|---|---|---|---|---|
| | Dosage | Dosage | Tensile | | % gain | Tensile | | % gain |
| | of WSR | of DSR | Index | 95% | from | Index | 95% | from |
| Conditions | (wt %) | (wt %) | (N*m/g) | CI | blank | (N*m/g) | CI | blank |
| Blank | 0 | 0 | 34.7 | 2.1 | 0% | 1.1 | 0.1 | 0% |
| PAE (1) | 0.225 | 0 | 41.8 | 2.9 | 20% | 5.8 | 0.3 | 420% |
| PAE (1) + | 0.225 | 0.1 | 46.9 | 1.9 | 35% | 6.7 | 0.5 | 502% |
| APAM | | | | | | | | |
| PAE (1) + | 0.225 | 0.2 | 49.3 | 2.1 | 42% | 5.9 | 0.6 | 425% |
| APAM | | | | | | | | |
| PAE (1) + | 0.225 | 0.1 | 52.0 | 3.0 | 50% | 7.2 | 0.5 | 547% |
| AGPAM-3 | | | | | | | | |

As seen from Table 4, the use of a combination of PAE resin and AGPAM-3 according to the present invention as the strength agents also results in much higher dry tensile gain (35% by APAM at 0.1 wt % & 42% by APAM at 0.2 wt % vs 50% by AGPAM-3 at 0.1 wt %) and wet tensile gain (502% by APAM vs 547% by AGPAM-3) than the combination of PAE resin and APAM.

### (4) Charge Density of AGPAM

This example studied the impact of charge density of AGPAM on strength gain in the range from 1.28 to 4.20 meg/g. The thick stock used in this Example was a mixed slurry of 70% bleached softwood kraft (SWK) and 30% broke. The dosage of PAE in this Example is 0.35 wt % and AGPAM is 0.125 wt %.

As seen from Table 5, all AGPAM studied in this example shows effectiveness in boosting dry and wet tensile gain. However, AGPAM-2 achieves the greatest overall gain in both dry and wet tensile strength compared to the other three samples. This suggests that strength gain is not directly proportional to polymer charge density. There is an optimal range of charge density for maximizing strength gain.

TABLE 5
Composition and dosage of paper-making chemical
additives and measured sheet strength properties.

| | | | Dry | | | Wet | | |
|---|---|---|---|---|---|---|---|---|
| | Dosage of | Dosage of | Tensile | | % gain | Tensile | | % gain |
| | WSR | DSR | Index | 95% | from | Index | 95% | from |
| Conditions | (wt %) | (wt %) | (N*m/g) | CI | blank | (N*m/g) | CI | blank |
| Blank | 0 | 0 | 23.3 | 0.9 | 0% | 0.6 | 0.06 | 0% |
| PAE (1) | 0.35 | 0 | 26.9 | 0.7 | 15% | 5.7 | 0.38 | 780% |
| PAE (1) + | 0.35 | 0.125 | 29.5 | 0.6 | 26% | 6.9 | 0.24 | 963% |
| AGPAM-1 | | | | | | | | |
| PAE (1) + | 0.35 | 0.125 | 31.8 | 0.6 | 36% | 7.1 | 0.20 | 1000% |
| AGPAM-2 | | | | | | | | |
| PAE (1) + | 0.35 | 0.125 | 31.1 | 1.6 | 33% | 6.5 | 0.32 | 905% |
| AGPAM-3 | | | | | | | | |
| PAE (1) + | 0.35 | 0.125 | 29.7 | 0.6 | 28% | 6.3 | 0.19 | 871% |
| AGPAM-4 | | | | | | | | |

(5) Machine Trial for Comparison with APAM

A commercial machine trial was run on a through-air drying (TAD) machine. This is against the mill incumbent strength program of PAE-1 as WSR and APAM as DSR. Before trial started, the average PAE usage is 0.725 wt % and APAM usage is 0.275 wt %. During the trial, the following benefits were observed:
a. About 35% reduction in WSR dosage and about 40% reduction in DSR dosage while maintaining every strength target.
b. About 7% energy saving on TAD due to about 17% increase in Freeness from 43° to 33°.
c. About 20% fiber saving due to improvement on fiber retention.
d. About 50% defoamer reduction with greatly reduced foaming in effluent systems.
   (6) Machine Trial for Comparison with GPAM 30 APAM

A commercial machine trial was run on a conventional tissue machine. This is against the mill incumbent strength program of PAE-1 as WSR and GPAM plus APAM as DSR. Before trial started, the average PAE usage is 0.625 wt %, GPAM and APAM usages are 0.125 wt %, respectively. During the trial, the following benefits were observed:
a. About 30% reduction in WSR dosage and about 45% reduction in DSR dosage with about 20% increase in dry and wet strength.
b. About 12% increase in machine speed from 1190 to 1330 meter per minute.
c. About 12.5% increase in first pass retention.
d. About 35% reduction in needle power pressure from 16.6 to 10.8 bar.

All references, including publications, patent applications, and patents, cited herein are hereby incorporated by reference to the same extent as if each reference were individually and specifically indicated to be incorporated by reference and were set forth in its entirety herein.

Embodiments of the present disclosure are described herein, including the best mode known to the inventors for carrying out the invention. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While this invention may be embodied in many different forms, there are described in detail herein exemplary embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments mentioned herein, described herein and/or incorporated herein. In addition the invention encompasses any possible combination that also specifically excludes any one or some of the various embodiments mentioned herein, described herein and/or incorporated herein.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein, then any such conflicting information in such incorporated by reference material is specifically not incorporated by reference herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages and proportions herein are by weight unless otherwise specified. G/A (glyoxal to amide) ratios disclosed herein are based on mole ratios. Further, the NMR results disclosed herein are based on mole ratios.

The recitation of any numerical range by endpoints is meant to include the endpoints of the range, all numbers within the range, and any narrower range within the stated range (e.g. 1 to 5 includes 1, 1.5, 2, 2.75, 3, 3.8, 4, and 5). Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

This completes the description of the preferred and alternate embodiments of the invention. Those skilled in the art may recognize other equivalents to the specific embodiment described herein which equivalents are intended to be encompassed by the claims attached hereto.

We claim:

1. A paper strength additive composition, said composition comprising: an anionic dialdehyde-modified polymeric dry strength resin and a cationic wet strength resin, wherein said anionic dry strength resin has a charge density in the range of about 1.0 to about 6.0 meg/g.

2. The composition of claim 1, wherein said anionic dry strength resin is a dialdehyde-modified polymer mixture comprising a solvent and a dialdehyde modified polymer comprising:
a polymer backbone comprising:
i. one or more monomer unit(s) derived from a monomer of Formula I: 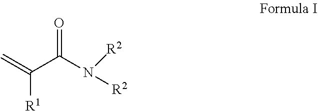
wherein R¹ is H or C₁-C₄ alkyl and each R₂ is independently selected from H or a linear or branched C₁-C₁₀ aliphatic group, and
ii. about 3 mol % to about 50 mol % of one or more anionic monomer unit(s).

3. The composition of claim 2, wherein the one or more anionic monomer unit(s) is derived from a monomer selected from 2-acrylamido-2-methylpropane sulfonic acid (“AMPS”), 2-acrylamido-2-methylbutane sulfonic acid (“AMBS”), [2-methyl-2-[(1-oxo-2-propenyl)amino]propyl]-phosphonic acid, methacrylic acid, acrylic acid, salts thereof, and combinations thereof.

4. The composition of claim 2, wherein the monomer of Formula I is acrylamide, methacrylamide, ethylacrylamide, N-methyl acrylamide, N-butyl acrylamide, or any combination thereof.

5. The composition of claim 2, wherein the dialdehyde-modified polymer is modified with a dialdehyde selected from glyoxal, malondialdehyde, succinic dialdehyde, and glutaraldehyde.

6. The composition of claim 2, wherein the dialdehyde-modified polymer has a weight average molecular weight in the range of about 50 kDa to about 3,000 kDa.

7. The composition of claim 2, wherein the polymer backbone has a weight average molecular weight in the range of about 2 kDa to about 100 kDa in the absence of the dialdehyde modification.

8. The composition of claim 2, wherein the dialdehyde-modified polymer mixture has a solids content in the range of about 1 wt. % to about 40 wt. %.

9. The composition of claim 2, wherein the dialdehyde-modified polymer mixture is an anionic glyoxylated polyacrylamide (AGPAM).

10. The composition of claim 1, wherein said cationic wet strength resin is either a temporary wet strength resin like GPAM or a permanent wet strength resin like polyaminoamide-epichlorohydrin (PAE), urea-formaldehyde resin, melamine-formaldehyde resin, polyamines and polyethylene imides epichlorohydrin, or hydrolyzed N-vinylformamide.

11. A method of increasing the strength of tissue paper or towel paper, said method comprising contacting an anionic dialdehyde-modified polymeric dry strength resin with a charge density in the range of about 1.0 to about 6.0 meg/g at neutral pH and a cationic wet strength resin, with fiber during the papermaking process.

12. The method of claim 11, wherein said contacting comprises adding said cationic wet strength resin to process water during the towel paper making process, and adding said anionic dialdehyde-modified polymeric dry strength resin composition to thin stock, thick stock, the headbox, before the headbox, after the headbox, or before a press section, and any combination thereof.

13. The method of claim 11, wherein said anionic dialdehyde-modified polymeric dry strength resin comprises a polymer backbone comprising:
i. one or more monomer unit(s) derived from a monomer of Formula I: 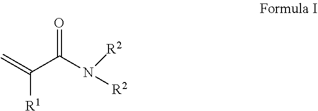
wherein R¹ is H or C₁-C₄ alkyl and each R₂ is independently selected from H or a linear or branched C₁-C₁₀ aliphatic group, and
ii. about 3 mol % to about 50 mol % of one or more anionic monomer unit(s).

14. A paper making slurry comprising an anionic dialdehyde-modified polymeric dry strength resin, a cationic wet strength resin, water, and fiber, wherein the slurry has a consistency in the range of about 0.05% to about 0.3%, and wherein said dry strength resin has an anionic charge density in the range of about 1.0 to about 6.0 meg/g at neutral pH.

15. The slurry of claim 14, wherein said fiber is a wood fiber, a non-wood (alternative/agricultural/residue) fiber, or a recycle fiber.

16. The slurry of claim 14, wherein said wood fiber comprises fibers from hardwood/deciduous trees or fibers from softwood/coniferous.

17. The slurry of claim 14, wherein said non-wood wood (alternative/agricultural/residue) fiber comprises fibers from bamboo, bagasse, wheat straw, hemp, esparto, switchgrass, sorghum, or miscanthus, and combinations thereof.

18. The slurry of claim 14, wherein said recycle fiber comprises fibers from graphic papers or from boards and packages.
